(19) United States
(12) Patent Application Publication
(10) Pub. No.: US 2014/0196096 A1
(43) Pub. Date: Jul. 10, 2014

(54) BROADCAST WAVE RECEIVING DEVICE AND METHOD, BROADCAST WAVE TRANSMITTING DEVICE AND METHOD, PROGRAM, AND RECORDING MEDIUM

(71) Applicants: Naohisa Kitazato, Tokyo (JP); Izumi Hatakeyama, Tokyo (JP); Masayuki Obayashi, Kanagawa (JP)

(72) Inventors: Naohisa Kitazato, Tokyo (JP); Izumi Hatakeyama, Tokyo (JP); Masayuki Obayashi, Kanagawa (JP)

(73) Assignee: SONY CORPORATION, Tokyo (JP)

(21) Appl. No.: 14/240,188

(22) PCT Filed: Aug. 30, 2012
(86) PCT No.: PCT/JP2012/071968

§ 371 Date: Feb. 21, 2014

(30) Foreign Application Priority Data
Sep. 6, 2011 (JP) 2011-193528

(51) Int. Cl. H04H 40/09; H04N 21/61

(52) U.S. Cl. CPC H04H 40/09; H04N 21/6112
USPC 725/62

(57) ABSTRACT

The present technique relates to a broadcast wave receiving device and method, a broadcast wave transmitting device and method, a program, and a recording medium that realize universal tuning that enables selection of multi-segment broadcasting only through broadcast reception while utilizing existing infrastructures.

A center segment that is in a predetermined segment location in a predetermined physical channel is selected. A check is made to determine whether a connected transmission descriptor in which information about OFDM synchronization among the segments in the predetermined physical channel is written is acquired, the connected transmission descriptor being contained in a transport stream that is broadcast in the selected center segment. When the connected transmission descriptor is acquired, the segments other than the center segment in the physical channel are sequentially selected, and tuning information contained in the transport stream of each of the selected segments is acquired to create a tuning table.

### TECHNICAL FIELD

The present technique relates to broadcast wave receiving devices and methods, broadcast wave transmitting devices and methods, programs, and recording media, and more particularly, to a broadcast wave receiving device and method, a broadcast wave transmitting device and method, a program, and a recording medium that realize universal tuning that enables selection of multi-segment broadcasting only through broadcast reception while utilizing existing infrastructures.

### BACKGROUND ART

In recent years, digital terrestrial broadcasting has been conducted in the UHF (Ultra High Frequency) band. A physical channel of digital terrestrial broadcasting is divided into 13 segments, and broadcasting for mobile terminals is conducted in a band equivalent to one of those segments. Broadcasting for fixed terminals such as television receivers is conducted in the bands equivalent to the other 12 segments (see Patent Document 1, for example).

Terminals compatible with one-segment broadcasting for mobile terminals have already been widely spread mainly as mobile phones, and the same content as the broadcasting for fixed terminals is currently broadcast. One-segment broadcasting for mobile terminals is normally referred to as “1-Seg broadcasting”.

Among the 13th through 52nd channels in the UHF band, there are a number of unused channels, except for the channels in which the above mentioned digital terrestrial broadcasting is actually conducted in respective areas, and effective use of those unused channels is being considered. Particularly, multi-segment broadcasting for simultaneously transmitting a large number of 1-Seg broadcasts by fully utilizing the 13 segments in one physical channel is beginning to be recognized as effective.

For example, of the 13th through 52nd channels for digital terrestrial broadcasting, there are a number of unused channels, except for the channels in which digital terrestrial broadcasting is actually conducted in respective areas. Therefore, effective use of those unused channels is being considered.

The following two models have been considered as service models of multi-segment broadcasting.

One is a method called 1-Seg retransmission, which is a service for collectively retransmitting 1-Seg broadcasts of digital terrestrial broadcasting as multi-segments in a bad reception area such as an underground mall.

The other one is a method called area-limited broadcasting (also referred to as community broadcasting), which is a service to provide area-limited 1-Seg broadcasts multilaterally by using more than one channel in a densely populated area, for example.

### CITATION LIST

### Patent Document

Patent Document 1: JP 2007-329847 A

### DISCLOSURE OF THE INVENTION

### Problems to be Solved by the Invention

Meanwhile, a conventional mobile terminal is designed to scan the TS (Transport Stream) of the center segment of each physical channel, and acquire tuning information from the NIT (Network Information Table) of its own segment contained in the TS.

Therefore, where multi-segment broadcasting is conducted in an unused channel, the tuning information about the center segment of the unused channel can be acquired, but the tuning information about the segments other than the center segment cannot be acquired. As a result, a 1-Seg receiving terminal such as a conventional mobile terminal cannot freely select multi-segment broadcasts.

An experiment has already been conducted to transmit and receive radio waves having signals of 1-Seg broadcasts superimposed on one another in one physical channel. In this case, frequency information about each segment is sent to a receiving terminal by means other than broadcasting, so that a specific 1-Seg broadcast is selected by performing direct tuning.

Therefore, a universal tuning mechanism that can perform tuning only through broadcast reception is being studied as a future receiving terminal.

Where the UHF band as an existing infrastructure is used, the following requirements are expected to be satisfied: not to disrupt reception of existing digital terrestrial broadcasts; comply with digital terrestrial broadcasting system standards; and maintain interoperability.

Also, compatibility of existing 1-Seg receiving terminals with multi-segment broadcasting is expected to be realized at low costs, so as to spread such receiving terminals. Further, with the characteristics of multi-segment broadcasting such as area-limited broadcasting being taken into consideration, transmission facilities are expected to be realized at low costs.

The present technique is being disclosed in view of those circumstances, and arms to realize universal tuning that enables selection of multi-segment broadcasts only through broadcast wave reception while utilizing existing infrastructures.

### Solutions to Problems

A first aspect of the present technique is a broadcast wave receiving device including: a center segment selecting unit that selects a center segment in a predetermined segment location in a predetermined physical channel among segments obtained by dividing each of physical channels by frequency bands, the physical channels being acquired by dividing broadcast waves by frequency bands; a descriptor determining unit that determines whether a connected transmission descriptor is acquired, the connected transmission descriptor being information contained in a transport stream that is broadcast in the selected center segment, information about OFDM synchronization among the segments in the predetermined physical channel being written in the connected transmission descriptor; an other segment selecting unit that sequentially selects the segments other than the center segment in the physical channel when the connected transmission descriptor is acquired; and a tuning table creating unit that acquires tuning information contained in the transport stream of each of the selected segments, and creates a tuning table.

The broadcast waves may be broadcast waves of digital terrestrial broadcasting, and the descriptor determining unit may acquire an NIT (Network Information Table) contained in the transport stream that is broadcast in the center segment, and determine whether the connected transmission descriptor is acquired by determining whether the connected transmission descriptor is contained in the NIT.

The broadcast waves may be broadcast waves of digital terrestrial broadcasting. The descriptor determining unit may acquire an “NIT actual” contained in the transport stream that is broadcast in the center segment, and determine whether the connected transmission descriptor is acquired by determining whether the connected transmission descriptor is contained in the “NIT actual”. The other segment selecting unit may acquire an “NIT other” contained in the transport stream that is broadcast in the center segment, and select the segments other than the center segment by identifying the segment locations of the segments other than the center segment based on information written in the “NIT other”.

The other segment selecting unit may select a secondary segment by identifying a segment location of the secondary segment in the predetermined physical channel based on the description in the connected transmission descriptor, and select the segments other than the center segment by identifying the segment locations of the segments other than the center segment based on the information contained in the transport stream that is broadcast in the secondary segment.

The other segment selecting unit selects the segments other than the center segment by identifying the segment locations of the segments other than the center segment based on a bitmap written in the connected transmission descriptor.

The first aspect of the present technique is a broadcast wave receiving method including the steps of: selecting a center segment in a predetermined segment location in a predetermined physical channel among segments obtained by dividing each of physical channels by frequency bands, the physical channels being acquired by dividing broadcast waves by frequency bands, a center segment selecting unit selecting the center segment; determining whether a connected transmission descriptor is acquired, the connected transmission descriptor being information contained in a transport stream that is broadcast in the selected center segment, information about OFDM synchronization among the segments in the predetermined physical channel being written in the connected transmission descriptor, a descriptor determining unit determining whether the connected transmission descriptor is acquired; sequentially selecting the segments other than the center segment in the physical channel when the connected transmission descriptor is acquired, an other segment selecting unit sequentially selecting the segments other than the center segment; and acquiring tuning information contained in the transport stream of each of the selected segments, and creating a tuning table, a tuning table creating unit acquiring the tuning information and creating the tuning table.

The first aspect of the present technique is a program for causing a computer to function as a broadcast wave receiving device that includes: a center segment selecting unit that selects a center segment in a predetermined segment location in a predetermined physical channel among segments obtained by dividing each of physical channels by frequency bands, the physical channels being acquired by dividing broadcast waves by frequency bands; a descriptor determining unit that determines whether a connected transmission descriptor is acquired, the connected transmission descriptor being information contained in a transport stream that is broadcast in the selected center segment, information about OFDM synchronization among the segments in the predetermined physical channel being written in the connected transmission descriptor; an other segment selecting unit that sequentially selects the segments other than the center segment in the physical channel when the connected transmission descriptor is acquired; and a tuning table creating unit that acquires tuning information contained in the transport stream of each of the selected segments, and creates a tuning table.

In the first aspect of the present technique, a center segment in a predetermined segment location in a predetermined physical channel is selected from among segments obtained by dividing each of physical channels by frequency bands, the physical channels being acquired by dividing broadcast waves by frequency bands. A check is made to determine whether a connected transmission descriptor is acquired, the connected transmission descriptor being information contained in a transport stream that is broadcast in the selected center segment, information about OFDM synchronization among the segments in the predetermined physical channel being written in the connected transmission descriptor. When the connected transmission descriptor is acquired, the segments other than the center segment in the physical channel are sequentially selected, and tuning information contained in the transport stream of each of the selected segments is acquired to create a tuning table.

A second aspect of the present technique is a broadcast wave transmitting device including: a related information generating unit that generates related information about selection of a logical channel corresponding to segments obtained by dividing each of physical channels by frequency bands, the physical channels being obtained by dividing broadcast waves by frequency bands; a multiplexing unit that multiplexes the related information and audio data or video data, to incorporate the generated related information into a transport stream to be broadcast in a center segment in a predetermined segment location in a predetermined physical channel; and a transmitting unit that transmits the transport stream obtained through the multiplexing as a broadcast wave of the center segment, the related information containing information indicating that multi-segment broadcasting is conducted in the predetermined physical channel to transmit different broadcasts in the respective segments, and information for identifying segment locations of the segments in the predetermined physical channel.

The broadcast waves may be broadcast waves of digital terrestrial broadcasting, and the related information generating unit may generate a connected transmission descriptor as the information indicating that multi-segment broadcasting is conducted, the connected transmission descriptor being written in part of an NIT (Network Information Table) contained in the transport stream to be broadcast in the center segment, information about OFDM synchronization among the segments in the predetermined physical channel being written in the connected transmission descriptor.

The broadcast waves may be broadcast waves of digital terrestrial broadcasting, and the related information generating unit may generate a connected transmission descriptor as the information indicating that multi-segment broadcasting is conducted, the connected transmission descriptor being written in part of an “NIT actual” contained in the transport stream to be broadcast in the center segment, information about OFDM synchronization among the segments in the predetermined physical channel being written in the connected transmission descriptor. The related information generating unit may generate the information for identifying the segment locations of the segments other than the center segment in the predetermined physical channel, the information being written in an “NIT other” contained in the transport stream to be broadcast in the center segment.

The broadcast waves may be broadcast waves of digital terrestrial broadcasting, and the related information generating unit may generate a connected transmission descriptor as the information indicating that multi-segment broadcasting is conducted, the connected transmission descriptor being written in part of an NIT contained in the transport stream to be broadcast in the center segment, information about OFDM synchronization among the segments in the predetermined physical channel being written in the connected transmission descriptor. In the connected transmission descriptor, the related information generating unit may write information for identifying a segment location of a secondary segment in the predetermined physical channel. The information for identifying the segment locations of the segments other than the center segment in the predetermined physical channel is contained in a transport stream to be broadcast in the secondary segment.

The broadcast waves may be broadcast waves of digital terrestrial broadcasting, and the related information generating unit may generate a connected transmission descriptor as the information indicating that multi-segment broadcasting is conducted, the connected transmission descriptor being written in part of an NIT contained in the transport stream to be broadcast in the center segment, information about OFDM synchronization among the segments in the predetermined physical channel being written in the connected transmission descriptor. The related information generating unit may generate a bitmap written in the connected transmission descriptor as the information for identifying the segment locations of the segments other than the center segment in the predetermined physical channel.

The second aspect of the present technique is a broadcast wave transmitting method including the steps of: generating related information about selection of a logical channel corresponding to segments obtained by dividing each of physical channels by frequency bands, the physical channels being obtained by dividing broadcast waves by frequency bands, a related information generating unit generating the related information; multiplexing the related information and audio data or video data, to incorporate the generated related information into a transport stream to be broadcast in a center segment in a predetermined segment location in a predetermined physical channel, a multiplexing unit performing the multiplexing; and transmitting the transport stream obtained through the multiplexing as a broadcast wave of the center segment, a transmitting unit transmitting the transport stream, the related information containing information indicating that multi-segment broadcasting is conducted in the predetermined physical channel to transmit different broadcasts in the respective segments, and information for identifying segment locations of the segments in the predetermined physical channel.

The second aspect of the present technique is a program for causing a computer to function as a broadcast wave transmitting device that includes: a related information generating unit that generates related information about selection of a logical channel corresponding to segments obtained by dividing each of physical channels by frequency bands, the physical channels being obtained by dividing broadcast waves by frequency bands; a multiplexing unit that multiplexes the related information and audio data or video data, to incorporate the generated related information into a transport stream to be broadcast in a center segment in a predetermined segment location in a predetermined physical channel; and a transmitting unit that transmits the transport stream obtained through the multiplexing as a broadcast wave of the center segment, the related information containing information indicating that multi-segment broadcasting is conducted in the predetermined physical channel to transmit different broadcasts in the respective segments, and information for identifying segment locations of the segments in the predetermined physical channel.

In the second aspect of the present technique, related information about selection of a logical channel corresponding to segments obtained by dividing each of physical channels by frequency bands is generated, the physical channels being obtained by dividing broadcast waves by frequency bands; the related information is multiplexed with audio data or video data, so that the generated related information is incorporated into a transport stream to be broadcast in a center segment in a predetermined segment location in a predetermined physical channel; and the transport stream obtained through the multiplexing is transmitted as a broadcast wave of the center segment, the related information containing information indicating that multi-segment broadcasting is conducted in the predetermined physical channel to transmit different broadcasts in the respective segments, and information for identifying segment locations of the segments in the predetermined physical channel.

### Effects of the Invention

According to the present technique, universal tuning that enables selection of multi-segment broadcasting only through broadcast reception can be realized while existing infrastructures are utilized.

### BRIEF DESCRIPTION OF DRAWINGS

FIG. 1 is a flowchart for explaining a tuning table creation process to be performed by a mobile terminal that is a conventional 1-Seg receiving terminal.

FIG. 2 is a diagram showing example structures of an NIT and an SDT.

FIG. 3 is a diagram for explaining an example of a conventional scanning method.

FIG. 4 is a diagram for explaining assignment of bands for digital terrestrial broadcast waves.

FIG. 5 is a diagram for explaining area-limited broadcasting.

FIG. 6 is a diagram for explaining 1-Seg retransmission.

FIG. 7 is a diagram showing an example structure of multi-segment broadcasts transmitted in one unused channel in 1-Seg retransmission.

FIG. 8 is a diagram for explaining an example of multi-segment broadcasting of the centralized type.

FIG. 9 is a diagram for explaining an example of multi-segment broadcasting of the distributed type.

FIG. 10 is a diagram for explaining an example of multi-segment broadcasting of the hybrid type.

FIG. 11 is a diagram for explaining connection information.

FIG. 12 is a diagram for explaining methods of acquiring tuning information in multi-segment broadcasting.

FIG. 13 is a diagram for explaining the center segment scanning method.

FIG. 14 is a diagram for explaining the structures of NITs in a case where the center segment scanning method is implemented.

FIG. 15 is a diagram for explaining the 2-segment scanning method.

FIG. 16 is a diagram for explaining the structures of NITs in a case where the 2-segment scanning method is implemented.

FIG. 17 is a diagram for explaining example descriptions in a connected transmission descriptor.

FIG. 18 is a diagram for explaining an extension of descriptions in a connected transmission descriptor according to the 2-segment scanning method.

FIG. 19 is a diagram for explaining the all-segment scanning method.

FIG. 20 is a diagram for explaining an extension of descriptions in a connected transmission descriptor according to the all-segment scanning method.

FIG. 21 is a diagram showing an example of a bitmap.

FIG. 22 is a block diagram showing an example structure according to an embodiment of a multi-segment broadcast transmitting device to which the present technique is applied.

FIG. 23 is a flowchart for explaining an example of a multi-segment broadcast transmission process.

FIG. 24 is a block diagram showing an example structure according to an embodiment of a receiving terminal to which the present technique is applied.

FIG. 25 is a flowchart for explaining an example of a tuning table creation process to be performed by the receiving terminal shown in FIG. 24.

FIG. 26 is a diagram for explaining reception of digital terrestrial broadcasts by the receiving terminal to which the present technique is applied and a conventional receiving terminal.

FIG. 27 is a block diagram showing an example structure of a personal computer.

### MODES FOR CARRYING OUT THE INVENTION

The following is a description of embodiments of the technique disclosed herein, with reference to the drawings.

First, acquirement of tuning information (such as frequency information about each segment) by a conventional 1-Seg receiving terminal is described.

A physical channel of digital terrestrial broadcasting is divided into 13 segments, and broadcasting for mobile terminals is conducted in a band equivalent to one of those segments. Broadcasting for fixed terminals such as television receivers is conducted in the bands equivalent to the other 12 segments.

Terminals compatible with one-segment broadcasting for mobile terminals have already been widely spread mainly as mobile phones, and the same content as the broadcasting for fixed terminals is currently broadcast. One-segment broadcasting for mobile terminals is normally referred to as “1-Seg broadcasting”, and terminals compatible with one-segment broadcasting for mobile terminals is referred to as “1-Seg receiving terminals”, for example.

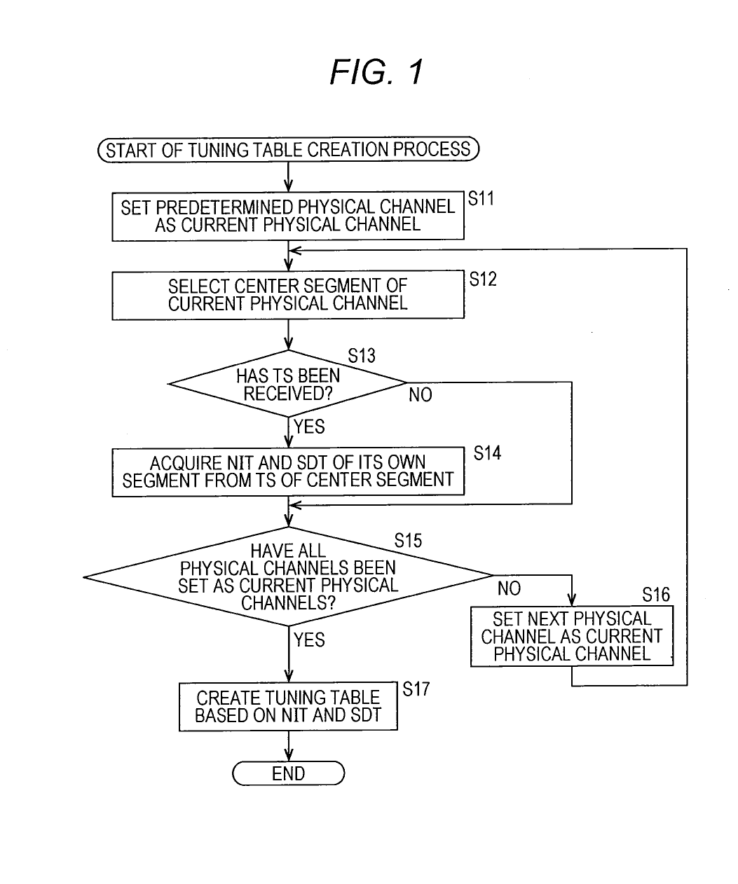

FIG. 1 is a flowchart for explaining an example of a process to be performed by a mobile terminal that is a conventional 1-Seg receiving terminal to acquire tuning information and create a tuning table (a tuning table creation process).

In step S11, the mobile terminal sets a predetermined physical channel (the physical channel with the lowest frequency, for example) as the current physical channel to be processed. In step S12, the mobile terminal selects the center segment of the current physical channel. In step S13, the mobile terminal determines whether the TS (Transport Stream) of the center segment of the current physical channel has been received. If it is determined that the TS has been received, the process moves on to step S14.

In step S14, the mobile terminal acquires the NIT (Network Information Table) of its own segment written as “NIT actual” and the SDT (Service Description Table) of its own segment written as “SDT actual” from the received TS. The process then moves on to step S15.

If it is determined in step S13 that the TS of the center segment has not been received, step S14 is skipped, and the process moves on to step S15.

In step S15, the mobile terminal determines whether all the physical channels have been selected as a current physical channel. If the mobile terminal determines in step S15 that not all the physical channels have been selected as a current physical channel, the mobile terminal in step S16 sets the next physical channel (the physical channel with the second highest frequency, for example) as the current physical channel, and the process returns to step S12. The mobile terminal repeats the procedures of steps S12 through S16 until all the physical channels have been selected as a current physical channel.

If the mobile terminal determines in step S15 that all the physical channels have been selected as a current physical channel, on the other hand, the mobile terminal in step S17 creates a tuning table based on the NITs and the SDTs acquired in step S14.

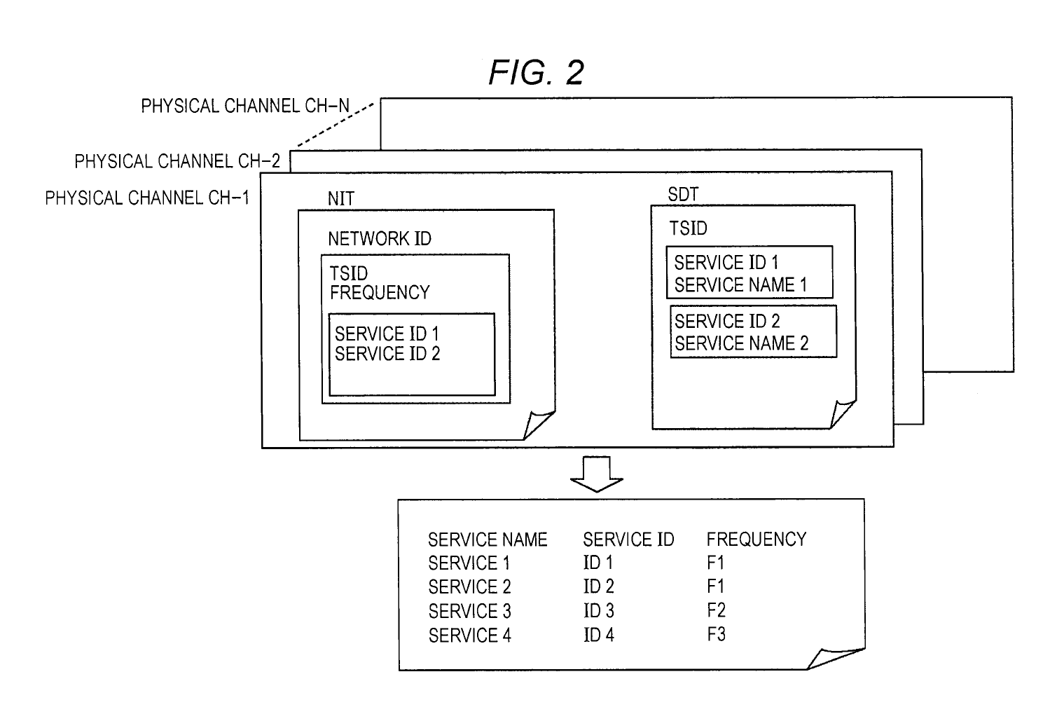

Specifically, in an NIT, the network ID unique to the network, the TSID unique to the TS, frequency, the service ID unique to the broadcasting service, and the like are written in relation to its own segment, as shown in FIG. 2. In an SDT, the TSID, the service ID, the service name, and the like of the broadcast service corresponding to its own segment are written as information related to the broadcasting service.

Therefore, as shown in FIG. 2, the mobile terminal creates a tuning table by acquiring the service IDs and the frequencies as the tuning information from the NITs of the center segments of the respective physical channels, and associating the service IDs and the frequencies with the service names acquired from the SDTs corresponding to the NITs.

In the example shown in FIG. 2, two broadcast services are broadcast in a time-sharing manner in the center segment of a physical channel 1 (physical CH-1), and therefore, two service IDs are written in the NIT of the center segment of the physical channel 1.

As the tuning table is created, tuning can be performed by the mobile terminal.

As described above, a conventional mobile terminal scans the TS of the center segment of each physical channel, and acquires tuning information from the NIT of its own segment contained in the TS.

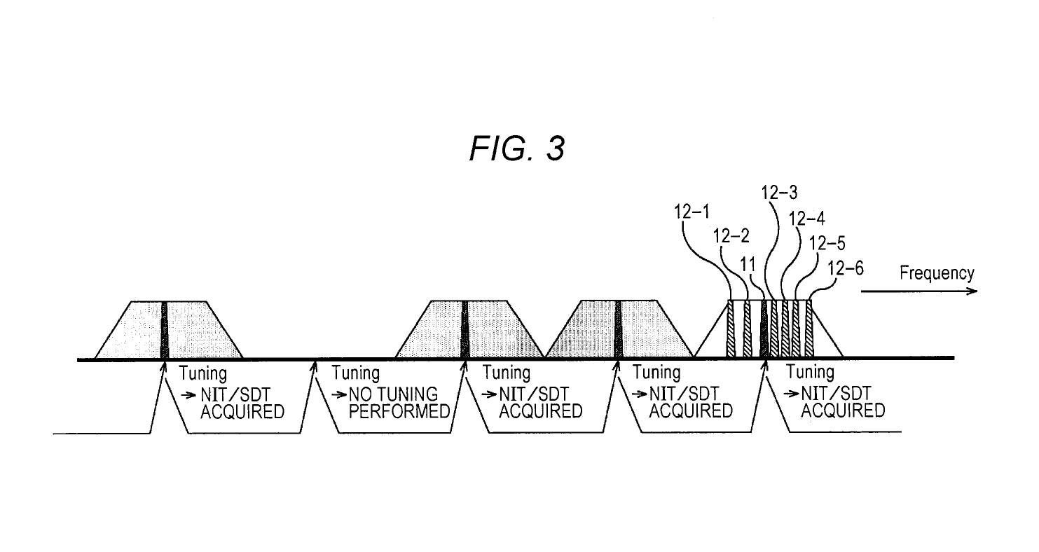

Therefore, the conventional mobile terminal can acquire the tuning information about the center segment 11 of a predetermined physical channel, but cannot acquire the tuning information about the segments 12-1 through 12-6 of the predetermined physical channel other than the center segment 11, as shown in FIG. 3, for example.

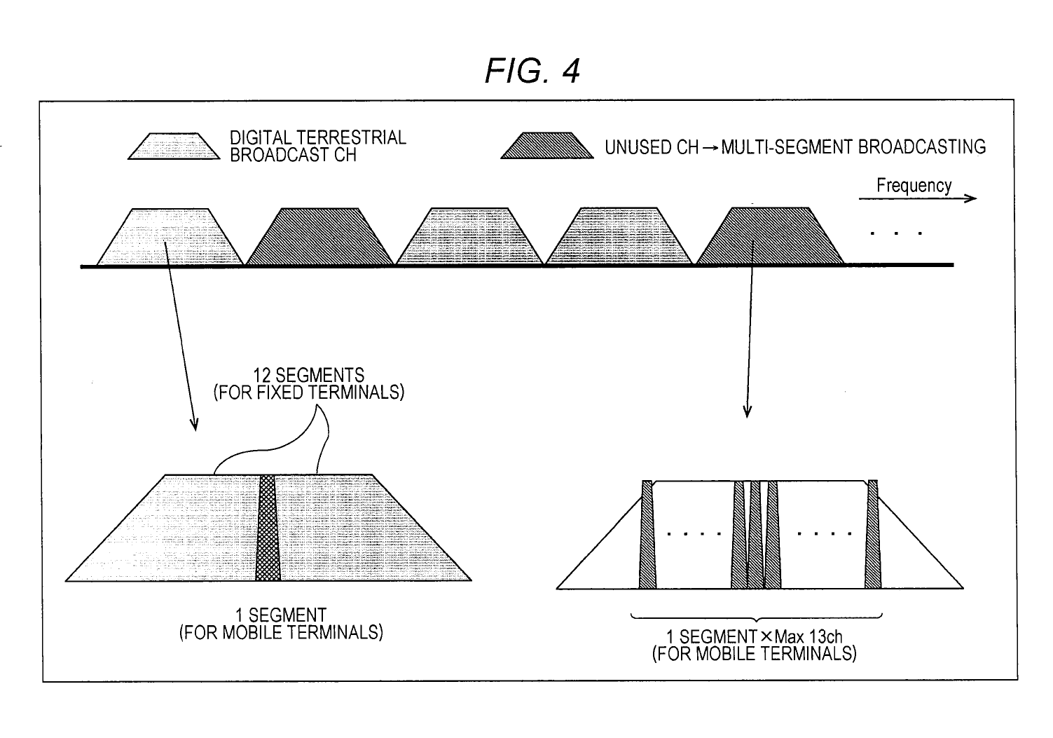

Next, multi-segment broadcasting in digital terrestrial broadcasting is described. FIG. 4 is a diagram for explaining assignment of bands for digital terrestrial broadcast waves.

As shown in FIG. 4, in the physical channels used for digital terrestrial broadcasting in all the bands of digital terrestrial broadcast waves, 1-Seg broadcasting is conducted in the band of the center segment, and broadcasting for fixed terminals is conducted in the bands of the other 12 segments. In an unused channel, 1-Seg rebroadcasts are transmitted as multi-segment broadcasts, for example.

It should be noted that a physical channel is a predetermined frequency band assigned beforehand to broadcast waves, and each of the trapezoids shown in the upper half of FIG. 4 is a physical channel. A segment is a predetermined frequency band assigned beforehand in a physical channel. Each of the stick-like figures shown in the lower half of FIG. 4 is a segment, and a maximum of 13 segments can be assigned to one physical channel. Each segment is also referred to as a logical channel.

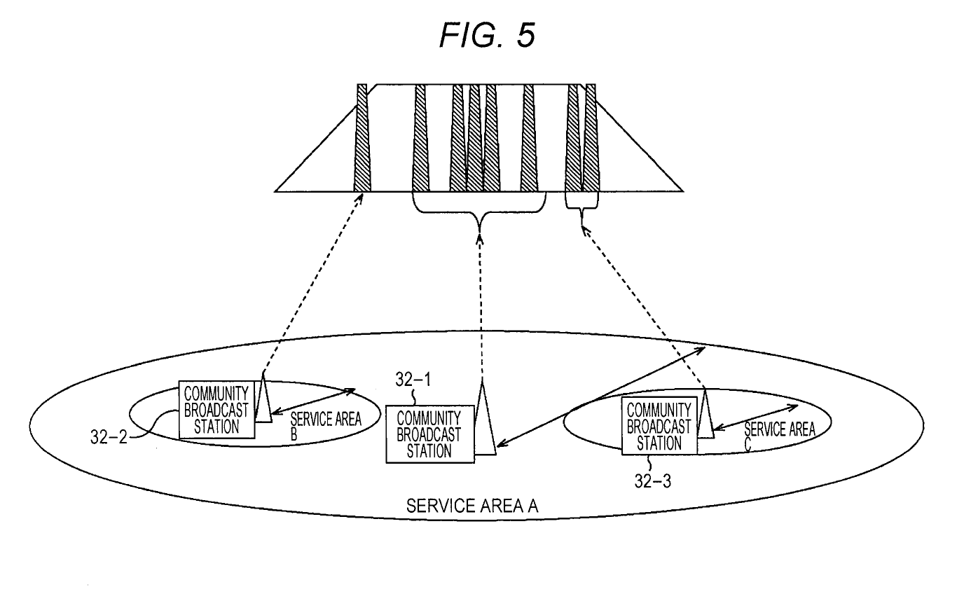

FIG. 5 is a diagram for explaining area-limited broadcasting (also referred to as community broadcasting) as one service model of multi-segment broadcasting.

As shown in FIG. 5, in the area-limited broadcasting, the respective segments to be broadcast in the unused channel shown in FIG. 4 are associated with a predetermined service area.

In the example shown in FIG. 5, a community broadcast station 32-1 is a broadcast station that broadcasts segments associated with a service area A that is a zone of 1 km or less in radius, for example. The community broadcast station 32-1 having a wide service area is referred to as the center station. A community broadcast station 32-2 and a community broadcast station 32-3 are broadcast stations associated with a service area B and a service area C such as a building located in the zone and an amusement park, and are referred to as local stations. In this example, the service area A contains the service areas B and C.

In the example shown in FIG. 5, eight logical channels are provided in one physical channel (unused channel). The leftmost logical channel in the drawing is the segment to be broadcast by the community broadcast station 32-2. The two rightmost logical channels in the drawing are the segments to be broadcast by the community broadcast station 32-3. The five center logical channels in the drawing are the segments to be broadcast by the community broadcast station 32-1.

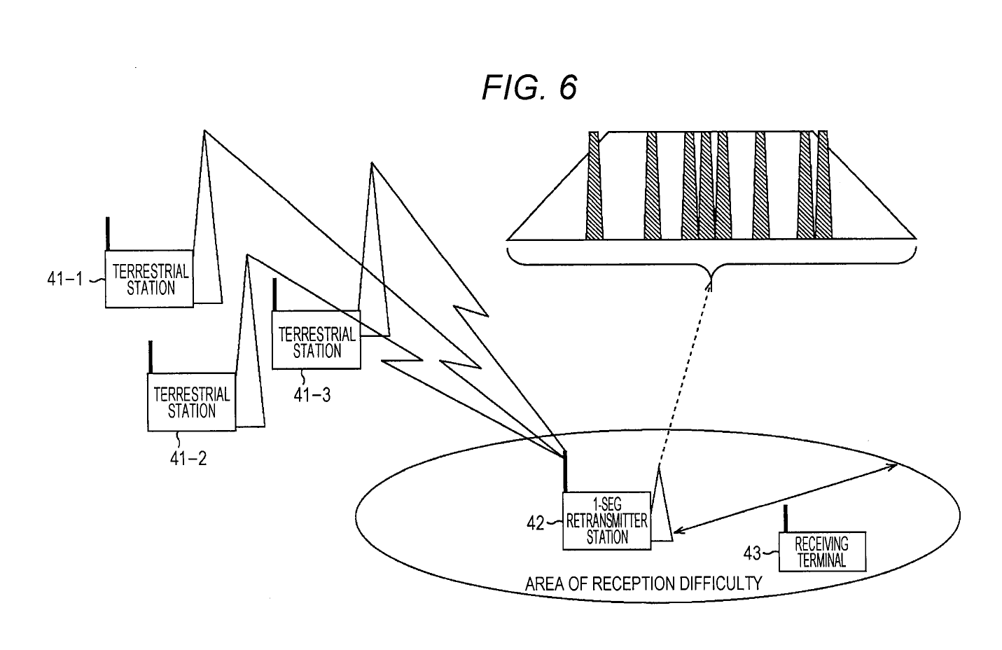

FIG. 6 is a diagram for explaining 1-Seg retransmission as one service model of multi-segment broadcasting.

As shown in FIG. 6, terrestrial stations 41-1 through 41-3 conduct digital terrestrial broadcasting with digital terrestrial broadcasting waves. Hereinafter, the terrestrial stations 41-1 through 41-3 will be collectively referred to as the terrestrial stations 41 as long as there is no need to distinguish them from one another.

A 1-Seg retransmitter station 42 receives 1-Seg broadcasts of digital terrestrial broadcasts transmitted from the terrestrial stations 41. The 1-Seg retransmitter station 42 then retransmits the 1-Seg broadcasts as multi-segment broadcasts to an area of reception difficulty, for example, using unused channels for digital terrestrial broadcasting. An area of reception difficulty is an area such as an underground mall where it is difficult to receive digital terrestrial broadcasts transmitted from the terrestrial stations 41.

A receiving terminal 43 is a mobile terminal that can receive 1-Seg broadcasts from the terrestrial stations 41 and 1-Seg broadcasts as multi-segment broadcasts from the 1-Seg retransmitter station 42. The 1-Seg broadcasts as multi-segment broadcasts transmitted from the 1-Seg retransmitter station 42 are also referred to as 1-Seg rebroadcasts.

As described above, with the 1-Seg retransmitter station 42 retransmitting 1-Seg broadcasts to the area of reception difficulty, for example, the receiving terminal 43 even in the area of reception difficulty can certainly receive the 1-Seg broadcasts.

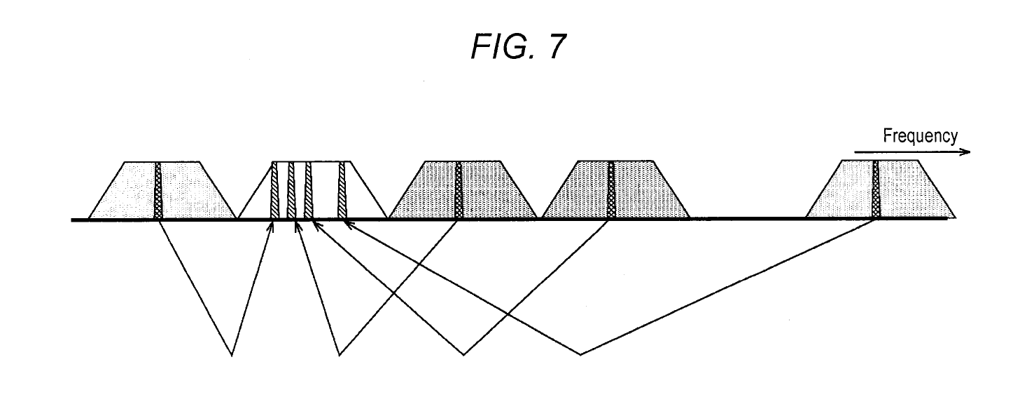

FIG. 7 is a diagram showing an example structure of multi-segment broadcasts transmitted in one unused channel in 1-Seg retransmission. In the shown in the drawing, the second physical channel from the left is an unused channel, and 1-Seg rebroadcasting is conducted in this physical channel. In the 1-Seg rebroadcasting in this example, 1-Seg broadcasts transmitted in the four center segments of the physical channels are collectively broadcast.

Next, broadcast wave transmission forms of multi-segment broadcasts are described. The broadcast wave transmission forms of multi-segment broadcasts are roughly classified into a centralized type, a distributed type, and a hybrid type.

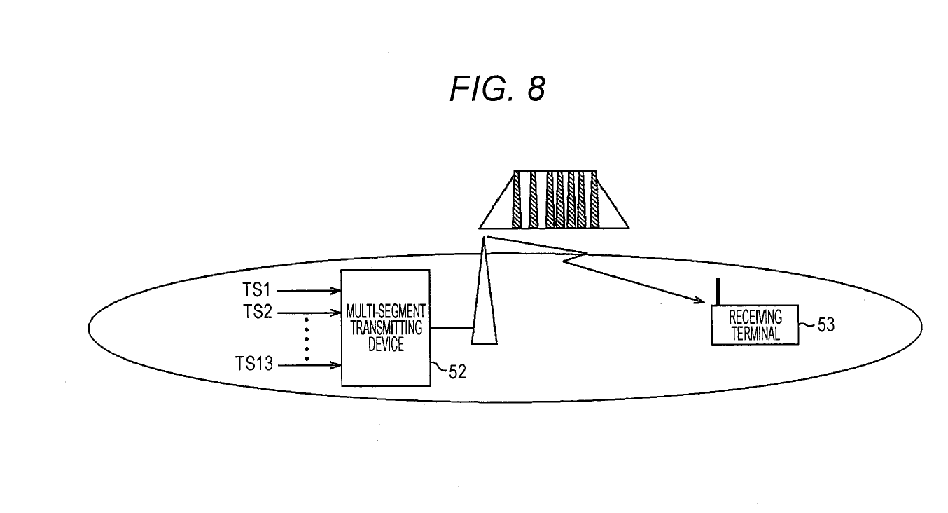

FIG. 8 is a diagram for explaining an example of multi-segment broadcasting of the centralized type. As shown in the drawing, in the case of the centralized type, a multi-segment transmitting device 52 transmits the TSs of 1-Seg rebroadcasts of all broadcast segments.

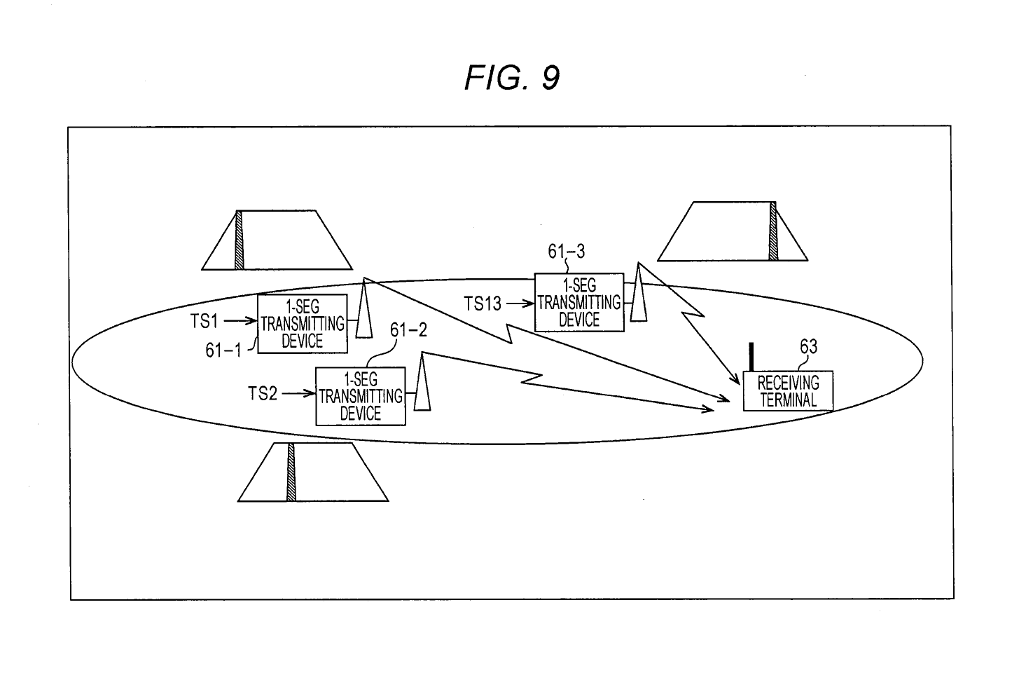

FIG. 9 is a diagram for explaining an example of multi-segment broadcasting of the distributed type. As shown in the drawing, in the case of the distributed type, the TSs of 1-Seg broadcasts are transmitted from different 1-Seg transmitting devices provided for respective broadcast segments. In this example, three 1-Seg transmitting devices 51-1 through 51-3 transmit the TSs of 1-Seg broadcasts associated with one logical channel.

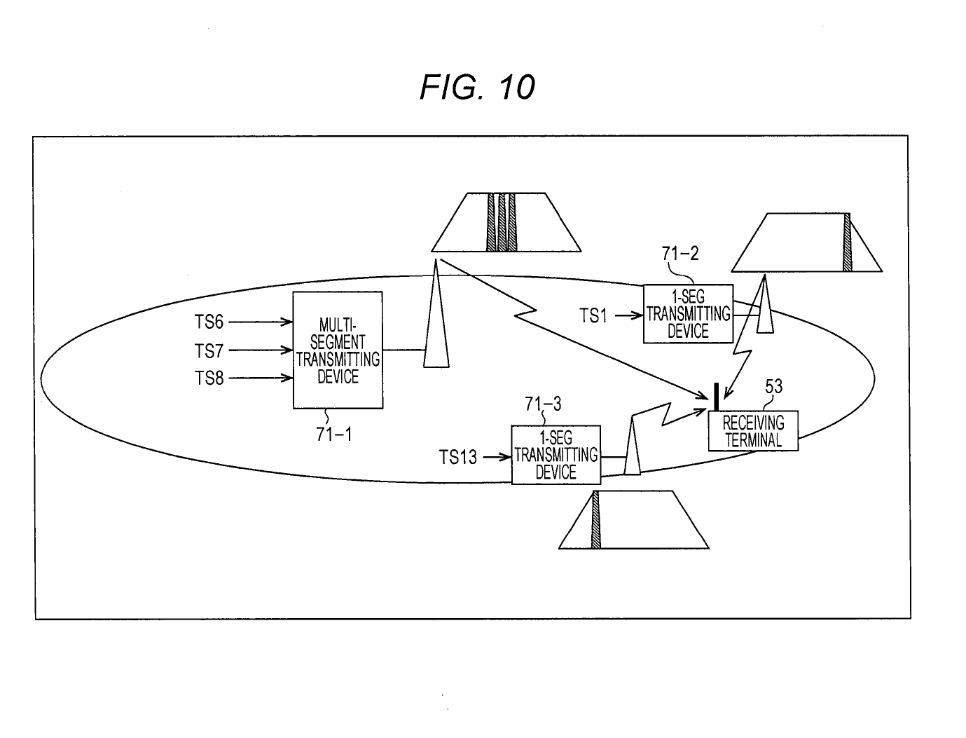

FIG. 10 is a diagram for explaining an example of multi-segment broadcasting of the hybrid type. As shown in the drawing, the hybrid type is a transmission form that is a hybrid of the centralized type shown in FIG. 8 and the distributed type shown in FIG. 9. In this example, a multi-segment transmitting device 71-1 transmits the TSs of 1-Seg broadcasts associated with three logical channels, and a 1-Seg transmitting device 71-2 and a 1-Seg transmitting device 71-3 each transmit the TSs of 1-Seg broadcasts associated with one logical channel.

Where the transmission form is of the distributed type or the hybrid type, the time required for tuning varies with the order of tuning among logical channels. Specifically, in a case where the logical channels of segments transmitted by the same multi-segment transmitting device are sequentially selected, OFDM synchronization is maintained among the segments. Therefore, if OFDM synchronization is skipped in a case where the logical channels of segments transmitted by the same multi-segment transmitting device are sequentially selected, the time required for tuning is shortened.

However, in a case where the logical channels of segments transmitted by different 1-Seg transmitting devices are sequentially selected, OFDM synchronization is performed, and the time required for tuning becomes longer accordingly.

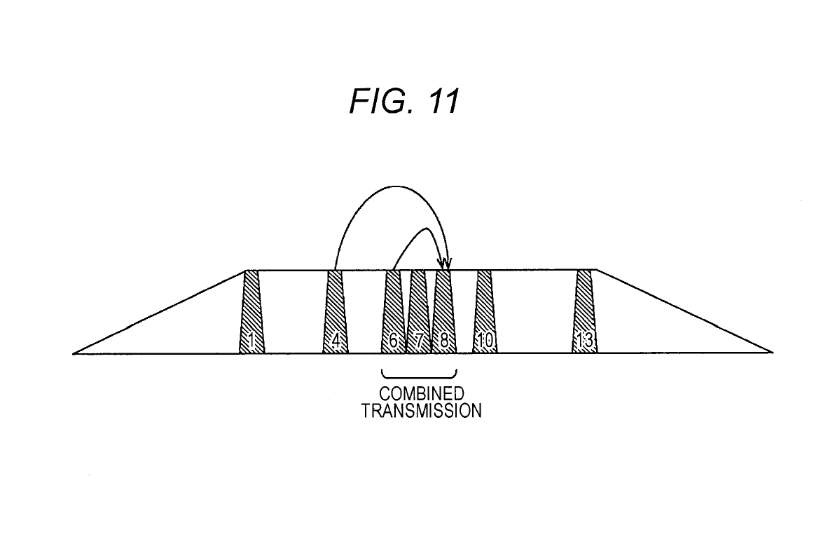

The time required for tuning can be shortened by causing a multi-segment transmitting device to transmit connection information and causing a receiving terminal to control the order of tuning based on the connection information, for example. For example, in a case where connection information indicates that the sixth and eighth segments are segments to be transmitted by the same multi-segment transmitting device, as shown in FIG. 11, a receiving terminal can switch the tuning object from the sixth segment to the eighth segment, without performing an OFDM synchronization process. As a result, the eight segments can be selected in a shorter period of time than in a case where the eighth segment is selected after a segment (the fourth segment, for example) transmitted by a different 1-Seg transmitting device, for example.

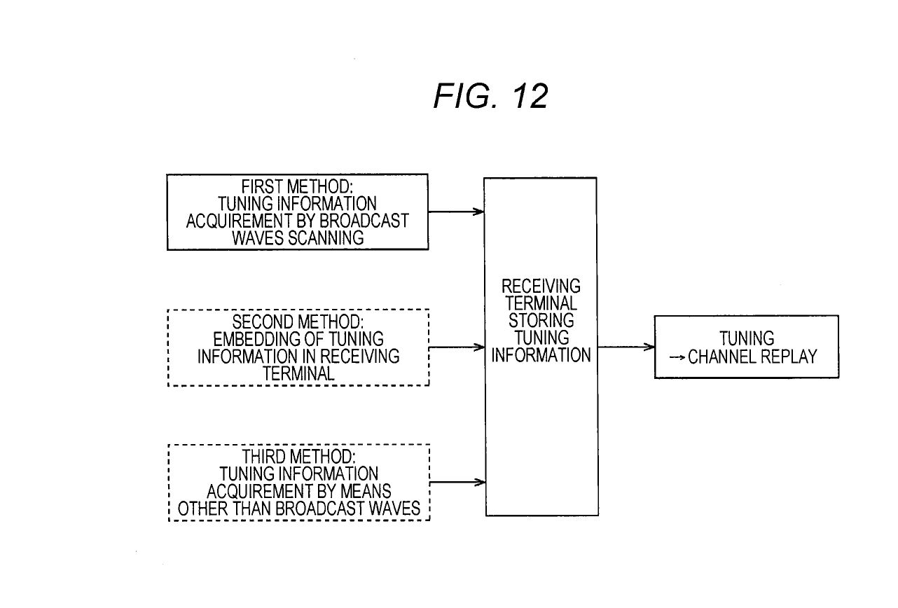

FIG. 12 is a diagram for explaining methods of acquiring tuning information in multi-segment broadcasting. As shown in FIG. 12, there are roughly three possible methods as methods of acquiring tuning information in multi-segment broadcasting.

A first method is a method of acquiring tuning information by scanning broadcast waves. By the first method, a receiving terminal can acquire tuning information about receivable multi-segment broadcasts simply by scanning digital terrestrial broadcast waves. Accordingly, the user who owns the receiving terminal does not need to pay attention to whether there are multi-segment broadcasts receivable at his/her own location, and can automatically acquire the tuning information about the receivable multi-segment broadcasts.

A second method is a method of embedding tuning information in a receiving terminal. By the second method, a receiving terminal needs to store tuning information in advance, but it is difficult to store all the tuning information about community broadcasting and 1-Seg retransmission that vary with areas, for example. In view of this, the second method is not suitable for community broadcasting and 1-Seg retransmission.

A third method is a method of acquiring tuning information by means of broadcast waves (communications via the Internet, for example). By the third method, a user who owns a receiving terminal needs to check whether there are multi-segment broadcasts receivable at his/her own location, and issue an instruction to acquire the tuning information about the multi-segment broadcasts. However, it is difficult to recognize all community broadcasting and 1-Seg retransmission that vary with areas, together with the areas, for example. In view of this, the third method is not suitable for community broadcasting and 1-Seg retransmission.

Accordingly, it is preferable to use the first method as a method of acquiring tuning information in multi-segment broadcasting.

As described above, a conventional receiving terminal is designed to scan the TS (Transport Stream) of the center segment of each physical channel, and acquire tuning information from the NIT (Network Information Table) of its own segment contained in the TS.

Therefore, where multi-segment broadcasting is conducted in an unused channel, the tuning information about the center segment of the unused channel can be acquired, but the tuning information about the segments other than the center segment cannot be acquired. As a result, a conventional receiving terminal cannot freely select multi-segment broadcasts.

An experiment has already been conducted to transmit and receive radio waves having signals of 1-Seg broadcasts superimposed on one another in one physical channel. In this case, frequency information about each segment is sent to a receiving terminal by means other than broadcasting, so that a specific logical channel is selected by performing direct tuning.

Therefore, a universal tuning mechanism that can perform tuning only through broadcast reception is being studied as a future receiving terminal.

In view of this, the first method is implemented as a method of acquiring tuning information about multi-segment broadcasts in the present technique. Specifically, terrestrial stations, community broadcast stations, and 1-Seg retransmitter stations transmit tuning information with digital terrestrial broadcast waves, and a receiving terminal acquires the tuning information by scanning the digital terrestrial broadcast waves, and then stores the acquired tuning information. The receiving terminal selects and replays a predetermined logical channel based on the stored tuning information.

Methods of acquiring tuning information by scanning according to the first method are further classified into three scanning methods. Hereinafter, the three scanning methods will be referred to as a center segment scanning method, a 2-segment scanning method, and an all-segment scanning method.

By the above mentioned three scanning methods, connected transmission descriptors are written in the NITs of the center segments of the physical channels in which multi-segment broadcasting is to be conducted, so that a receiving terminal can be notified of multi-segment broadcasting being conducted. A connected transmission descriptor describes connection information indicating that more than one segment is being transmitted from the same multi-segment transmitting device, as described above. Connected transmission descriptors are specified by ARIB (Association of Radio Industries and Broadcast).

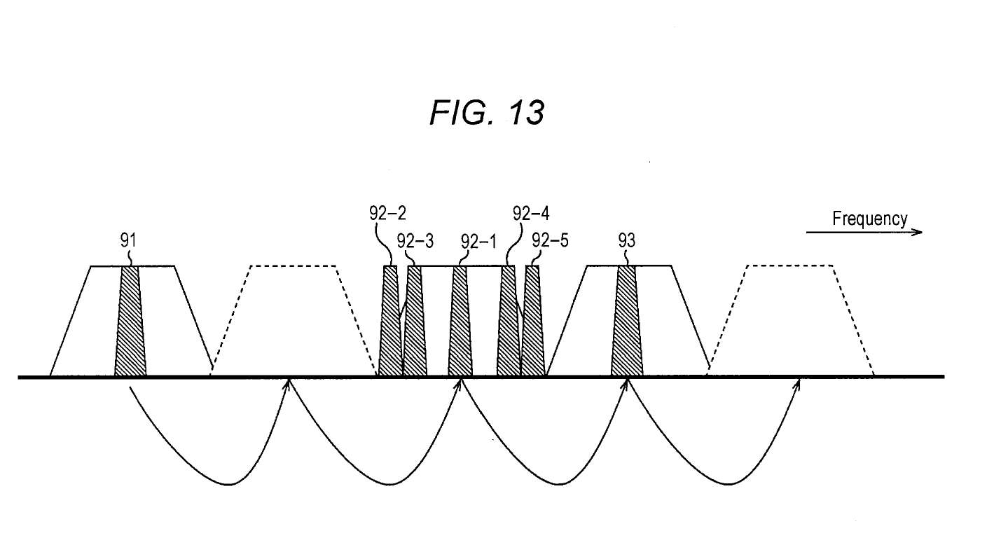

FIG. 13 is a diagram for explaining the center segment scanning method of the above mentioned three scanning methods. In the example shown in the drawing, there are five physical channels. In the leftmost physical channel and the second physical channel from the right in the drawing, signals of digital terrestrial broadcasting are transmitted. In the center physical channel in the drawing, signals of multi-segment broadcasting are transmitted. In the second physical channel from the left and the rightmost physical channel in the drawing, no signals for broadcasting are transmitted.

As indicated by the arrow in FIG. 13, by the center segment scanning method, a receiving terminal scans the center segments of the respective physical channels of digital terrestrial broadcast waves in ascending frequency order.

As a result, the TS of the center segment 91 of a physical channel and the TS of the center segment 93 of digital terrestrial broadcasting are acquired, and the NITs and the SDTs of the 1-Seg broadcasts to be broadcast in the center segment 91 and the center segment 93 are acquired from the TSs. Also, the TS of the center segment 92-1 of the physical channel of multi-segment broadcasting is acquired, and the NIT and the SDT of the multi-segment broadcast to be broadcast in the center segment 92-1 are acquired from the TS.

In the example shown in the drawing, five segments corresponding to segments 92-1 through 92-5 are operated among the 13 segments of the physical channel of multi-segment broadcasting. Here, the segments being operated are segments in which signals corresponding to information meaningful to a logical channel are broadcast, and the segments other than the segments 92-1 through 92-5 are not operated.

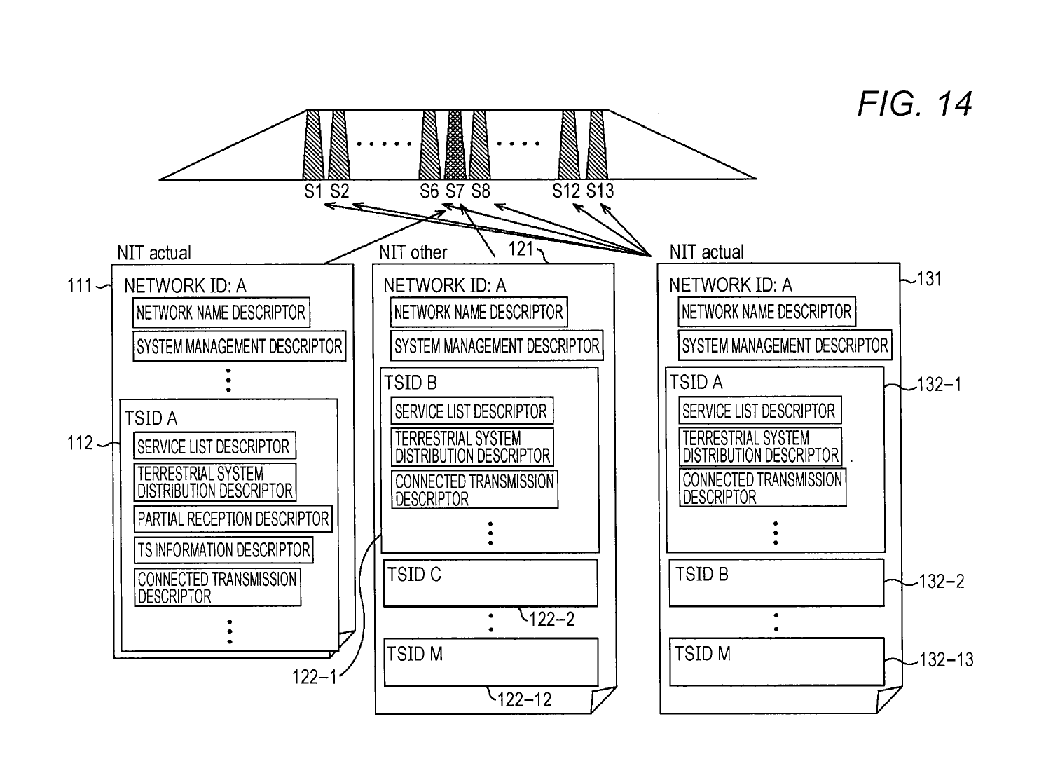

FIG. 14 is a diagram for explaining the structures of NITs in a case where the center segment scanning method is implemented in the present technique. Among NITs, there are NITs called “NIT actual” in which information about own segments is written, and NITs called “NIT other” in which information about the segments other than the own segments is written. It should be noted that “NIT actual” and “NIT other” are specified by ARIB.

An NIT 111 shown in the drawing is an NIT acquired from a segment S7 that is the center segment. The NIT 111 is an NIT actual in which information about the segment S7 is written. In the NIT 111, a network ID is assigned, and a network name descriptor, a system management descriptor, and the like are written.

In the NIT 111, a TS description area 112 is also provided. In the TS description area 112, information about the TS of the current segment (the segment S7 as the center segment) is written. In the TS description area 112, a TSID that is the ID unique to the current TS, a service list descriptor, a terrestrial system distribution descriptor, a partial reception descriptor, a TS information descriptor, a connected transmission descriptor, and the like are written.

As described above, in the present technique, a connected transmission descriptor is written in the NIT actual of the center segment, so that the physical channel including the center segment can be identified as a physical channel of multi-segment broadcasting.

An NIT 121 shown in FIG. 14 is an NIT other, and is an NIT in which information about the segments (segments S1 through S6 and segments S8 through S13) other than the segment S7 as the center segment is written.

In the NIT 121, a network name descriptor and a system management descriptor are written, and TS description areas 122-1 through 122-12 are provided. In the TS description areas 122-1 through 122-12, information about TSs of the segments S1 through S6 and the segments S8 through S13 is written.

In the present technique, the network ID of the NIT other may be the same as the network ID of the NIT actual.

Further, an NIT 131 shown in the drawing is an NIT actual, and is an NIT acquired from each of the TSs of the segments S1 through S6 and the segments S8 through S13. That is, the NITs acquired from the respective TSs of the 12 segments are collectively shown as the NIT 131.

In the NIT 131, a network name descriptor and a system management descriptor are written, and TS description areas 132-1 through 132-13 are provided. In the TS description areas 132-1 through 132-13, information about the segments S1 through S13 is written. Specifically, in the NITs actual acquired from the TS of the segments other than the center segment of the physical channel of multi-segment broadcasting, TS description areas corresponding to all the segments of the physical channel are provided.

Where the center segment scanning method is implemented, a receiving terminal determines whether the current physical channel is a physical channel of multi-segment broadcasting based on whether there is a connected transmission descriptor in the NIT actual (the NIT 111) of the center segment. When the current physical channel is a physical channel of multi-segment broadcasting, the receiving terminal can select the segments other than the center segment based on the descriptions in the TS description areas 122-1 through 122-12 of the NIT other. As a result, the NITs and the SDTs of all the segments being operated in the physical channel of multi-segment broadcasting are acquired, and a tuning table is created.

In this manner, scanning is performed by the center segment scanning method, and tuning information is acquired.

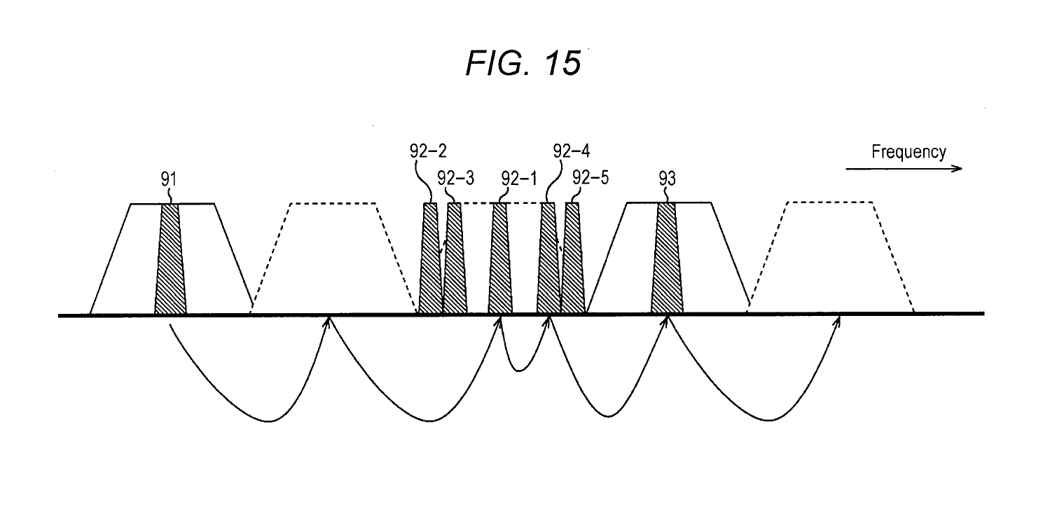

FIG. 15 is a diagram for explaining the 2-segment scanning method of the above mentioned three scanning methods. In the example shown in the drawing, there are five physical channels. In the leftmost physical channel and the second physical channel from the right in the drawing, signals of digital terrestrial broadcasting are transmitted. In the center physical channel in the drawing, signals of multi-segment broadcasting are transmitted. In the second physical channel from the left and the rightmost physical channel in the drawing, no signals for broadcasting are transmitted.

As indicated by the arrow in FIG. 15, by the 2-segment scanning method, a receiving terminal scans the center segments of the respective physical channels of digital terrestrial broadcast waves in ascending frequency order.

In the example shown in FIG. 15, however, a segment 92-4 in the center physical channel in the drawing is scanned after the center segment 92-1 of the same physical channel is scanned. The segment 92-4 is a segment designated based on the descriptions in the NIT contained in the TS of the center segment 92-1, and is referred to as the secondary segment herein.

After the secondary segment 92-4 is scanned, a center segment 93 is scanned.

As a result, the TS of the center segment 91 of a physical channel and the TS of the center segment 93 of digital terrestrial broadcasting are acquired, and the NITs and the SDTs of the 1-Seg broadcasts to be broadcast in the center segment 91 and the center segment 93 are acquired from the TSs. Also, the TS of the center segment 92-1 of the physical channel of multi-segment broadcasting is acquired, and the NIT and the SDT of the multi-segment broadcast to be broadcast in the center segment 92-1 are acquired from the TS. The TS of the secondary segment 92-4 is further acquired, and the NITs and the SDTs of the multi-segment broadcasts to be broadcast in the segments other than the center segment 92-1 are acquired from the TS.

In the example shown in the drawing, five segments corresponding to segments 92-1 through 92-5 are operated among the 13 segments of the physical channel of multi-segment broadcasting.

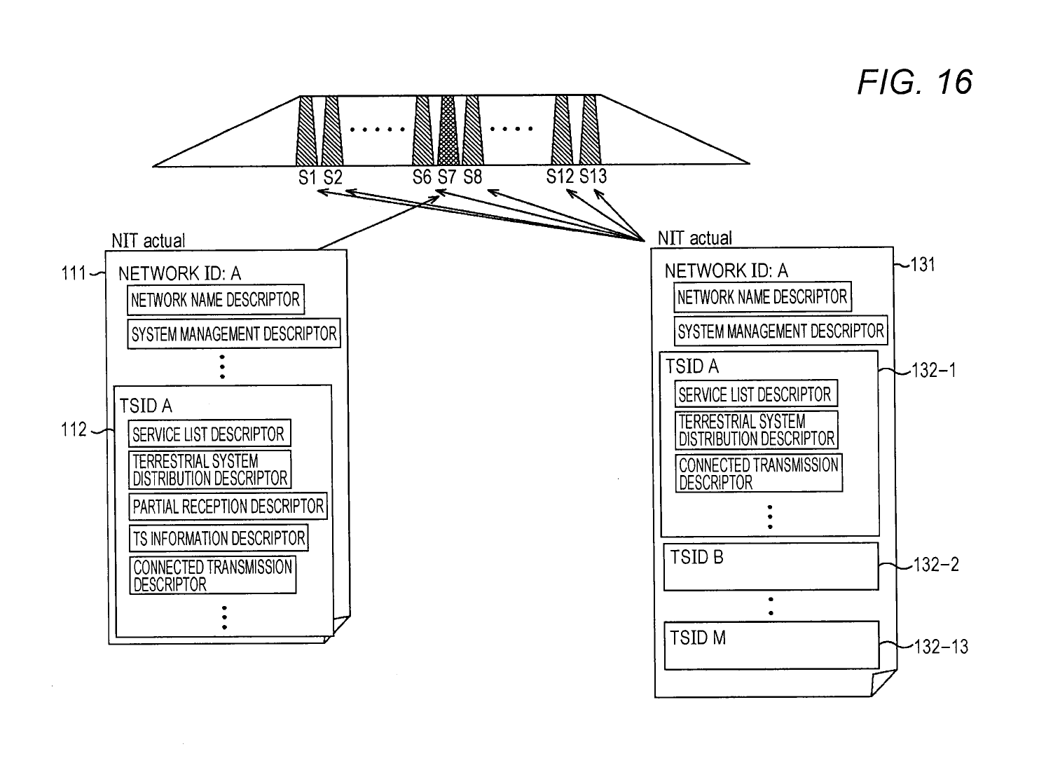

FIG. 16 is a diagram for explaining the structures of NITs in a case where the 2-segment scanning method is implemented in the present technique.

An NIT 111 shown in the drawing is an NIT acquired from a segment S7 that is the center segment. The NIT 111 is an NIT actual in which information about the segment S7 is written. In the NIT 111, a network ID is assigned, and a network name descriptor, a system management descriptor, and the like are written.

In the NIT 111, a TS description area 112 is also provided. In the TS description area 112, information about the TS of the current segment (the segment S7 as the center segment) is written. In the TS description area 112, a TSID that is the ID unique to the current TS, a service list descriptor, a terrestrial system distribution descriptor, a partial reception descriptor, a TS information descriptor, a connected transmission descriptor, and the like are written.

As described above, in the present technique, a connected transmission descriptor is written in the NIT actual of the center segment, so that the physical channel including the center segment can be identified as a physical channel of multi-segment broadcasting.

Further, an NIT 131 shown in the drawing is an NIT actual, and is an NIT acquired from each of the TSs of the segments S1 through S6 and the segments S8 through S13. That is, the NITs acquired from the respective TSs of the 12 segments are collectively shown as the NIT 131.

In the NIT 131, a network name descriptor and a system management descriptor are written, and TS description areas 132-1 through 132-13 are provided. In the TS description areas 132-1 through 132-13, information about the segments S1 through S13 is written. Specifically, in the NITs actual acquired from the TS of the segments other than the center segment of the physical channel of multi-segment broadcasting, TS description areas corresponding to all the segments of the physical channel are provided.

The structures of the NIT 111 and the NIT 131 shown in FIG. 16 (the 2-segment scanning method) are the same as those shown in FIG. 14 (the center segment scanning method). In the example case shown in FIG. 16 (the 2-segment scanning method), however, the descriptions in the connected transmission descriptor in the TS description area 112 in the NIT 111 are extended as follows.

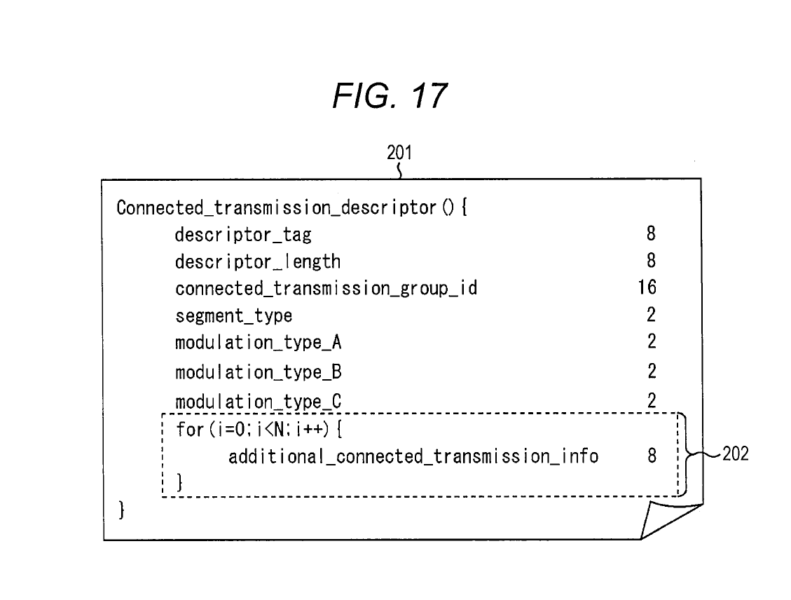

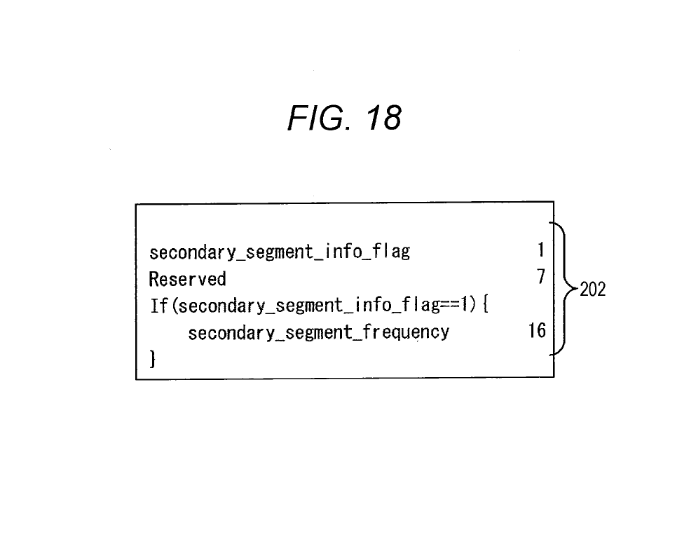

FIGS. 17 and 18 are diagrams for explaining an extension of descriptions in a connected transmission descriptor according to the 2-segment scanning method.

FIG. 17 shows descriptions in a connected transmission descriptor defined by ARIB. Specifically, descriptions including an 8-bit “descriptor_tag” and an 8-bit “descriptor_length” are specified, with a 2-bit “modulation_type_C” coming at the bottom. A description area 202 is designed so that additional transmission information (“additional_connected_transmission_info”) can be written therein if necessary.

By the present technique, when the 2-segment scanning method is implemented, descriptions are written in the description area 202 as shown in FIG. 18.

Specifically, a secondary segment information flag (“secondary_segment_info_flag”) is provided in the description area 202, as shown in FIG. 18. For example, in a case where the connected transmission descriptor including the description area is acquired from the TS of the segment S7 as the center segment of a physical channel of multi-segment broadcasting, the secondary segment information flag is on.

When the secondary segment information flag is on (“secondary_segment_info_flag==1”), the frequency of the secondary segment (“secondary_segment_frequency”) is then written. As the secondary segment, a segment that is assumed to be constantly operated in the current physical channel is selected, for example. In the example shown in FIG. 15, the segment 92-4 is selected as the secondary segment.

Where the 2-segment scanning method is implemented, a receiving terminal determines whether the current physical channel is a physical channel of multi-segment broadcasting based on whether there is a connected transmission descriptor in the NIT actual (the NIT 111) of the center segment. When the current physical channel is a physical channel of multi-segment broadcasting, the receiving terminal identifies and scans the secondary segment based on the content of the description in the description area 202 in the connected transmission descriptor. The receiving terminal can select any segment other than the center segment and the secondary segment based on the descriptions in the TS description areas 132-1 through 132-13 in the NIT 131 of the secondary segment. As a result, the NITs and the SDTs of all the segments being operated in the physical channel of multi-segment broadcasting are acquired, and a tuning table is created.

In this manner, scanning is performed by the 2-segment scanning method, and tuning information is acquired.

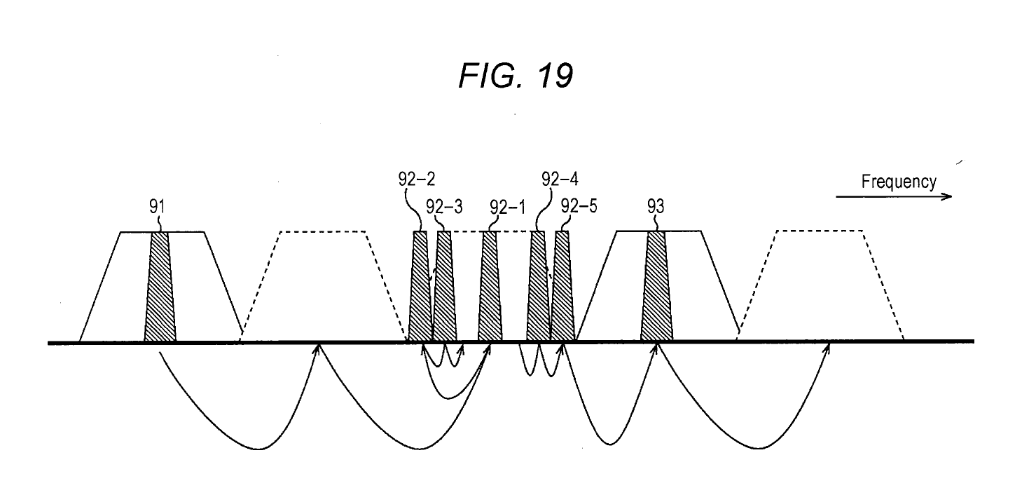

FIG. 19 is a diagram for explaining the all-segment scanning method of the above mentioned three scanning methods. In the example shown in the drawing, there are five physical channels. In the leftmost physical channel and the second physical channel from the right in the drawing, signals of digital terrestrial broadcasting are transmitted. In the center physical channel in the drawing, signals of multi-segment broadcasting are transmitted. In the second physical channel from the left and the rightmost physical channel in the drawing, no signals for broadcasting are transmitted.

As indicated by the arrow in FIG. 19, by the all-segment scanning method, a receiving terminal scans the center segments of the respective physical channels of digital terrestrial broadcast waves in ascending frequency order.

In the example shown in FIG. 19, however, a segment 92-2 in the center physical channel in the drawing is scanned after the center segment 92-1 of the same physical channel is scanned. Segments 92-3 through 92-5 in the same physical channel are then scanned from the left in the drawing.

After the segment 92-5 is scanned, a center segment 93 is scanned.

As a result, the TS of the center segment 91 of a physical channel and the TS of the center segment 93 of digital terrestrial broadcasting are acquired, and the NITs and the SDTs of the 1-Seg broadcasts to be broadcast in the center segment 91 and the center segment 93 are acquired from the TSs. Also, the TS of the center segment 92-1 of the physical channel of multi-segment broadcasting is acquired, and the NIT and the SDT of the multi-segment broadcast to be broadcast in the center segment 92-1 are acquired from the TS. Further, the respective TSs of the segments 92-2, 92-3, 92-4, and 92-5 in the physical channel of multi-segment broadcasting are acquired, and NITs and SDTs of multi-segment broadcasts are acquired from those TSs.

Where the all-segment scanning method is implemented, the structures of NITs are the same as those in the case described above with reference to FIG. 16, for example. In the example case shown in FIG. 19 (the all-segment scanning method), however, the descriptions in the connected transmission descriptor in the TS description area 112 in the NIT 111 are extended as follows.

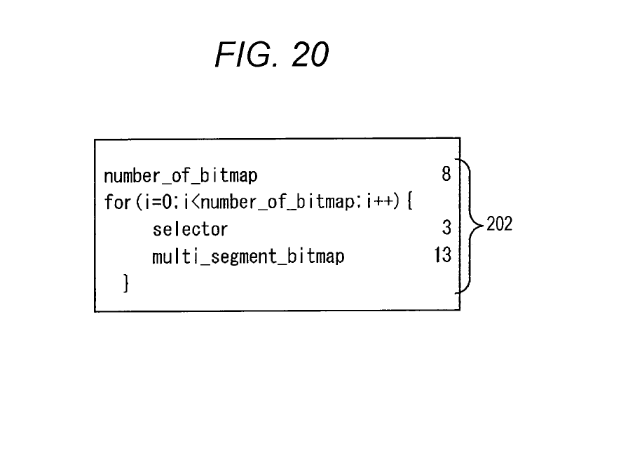

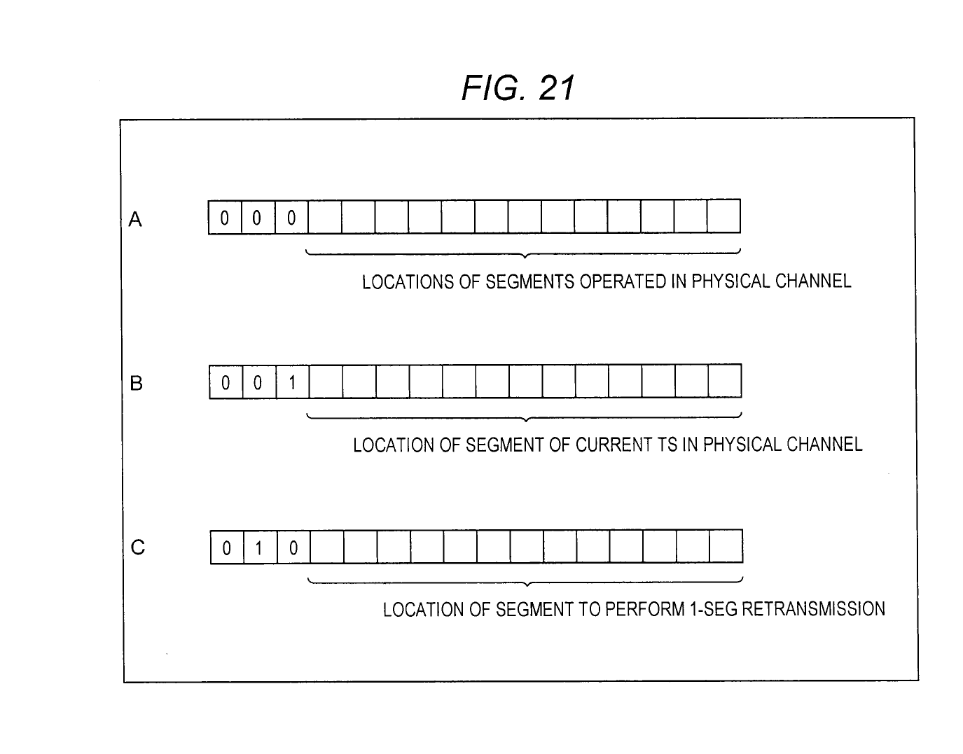

FIGS. 20 and 21 are diagrams for explaining an extension of descriptions in a connected transmission descriptor according to the all-segment scanning method.

By the present technique, when the all-segment scanning method is implemented, descriptions are written as shown in FIG. 20 in the description area 202 of the connected transmission descriptor shown in FIG. 17.

Specifically, a bitmap for identifying each segment of multi-segment broadcasting is written in the description area 202, as shown in FIG. 20. Here, the bitmap is designed to include a 3-bit selector (“selector”) and 13-bit multi-segment information (“multi_segment_bitmap”), for example.

As shown in A through C in FIG. 21, three kinds of bitmaps are provided, for example.

A in FIG. 21 is a bitmap indicating an operated segment layout. The bitmap indicating the operated segment layout is a bitmap for identifying the segment locations of the segments being operated in the current physical channel.

The selector (the first three bits) of the bitmap indicating the operated segment layout is “000”, and the respective 13 bits following the selector correspond to the segment locations in the current physical channel. For example, the locations of bits storing “1” among the 13 bits following the selector indicate the segment locations of the segments being operated in the current physical channel. Accordingly, a receiving terminal can identify the frequency of the segments being operated in the current physical channel, and scan each of the segments.

B in FIG. 21 is a bitmap indicating the location of its own segment. The bitmap indicating the location of its own segment is a bitmap for identifying the location of its own segment in the current physical channel.

The selector (the first three bits) of the bitmap indicating the location of its own segment is “001”, and the respective 13 bits following the selector correspond to the segment locations in the current physical channel. For example, the location of the bit storing “1” among the 13 bits following the selector indicates the segment location of its own segment in the current physical channel, and “1” is normally stored in the bit at the location corresponding to the center segment.

C in FIG. 21 is a bitmap indicating the location of a 1-Seg retransmission segment. The bitmap indicating the location of a 1-Seg retransmission segment is a bitmap for identifying the location of the segment assigned for 1-Seg retransmission in the current physical channel.

The selector (the first three bits) of the bitmap indicating the location of a 1-Seg retransmission segment is “010”, and the respective 13 bits following the selector correspond to the segment locations in the current physical channel. For example, the location of a bit storing “1” among the 13 bits following the selector indicates the segment location of the segment assigned for 1-Seg retransmission in the current physical channel. Accordingly, a receiving terminal can identify the frequency of the segment assigned for 1-Seg retransmission in the current physical channel. With this arrangement, a receiving terminal can sift through the descriptions related to frequency and the like in NITs contained in a TS of 1-Seg retransmission, for example.

Where the all-segment scanning method is implemented, a receiving terminal determines whether the current physical channel is a physical channel of multi-segment broadcasting based on whether there is a connected transmission descriptor in the NIT actual (the NIT 111) of the center segment. When the current physical channel is a physical channel of multi-segment broadcasting, the receiving terminal performs tuning by acquiring a bitmap based on the content of the description in the description area 202 in the connected transmission descriptor, and identifying the segment location of each segment. As a result, the NITs and the SDTs of all the segments being operated in the physical channel of multi-segment broadcasting are acquired, and a tuning table is created.

In this manner, scanning is performed by the all-segment scanning method, and tuning information is acquired.

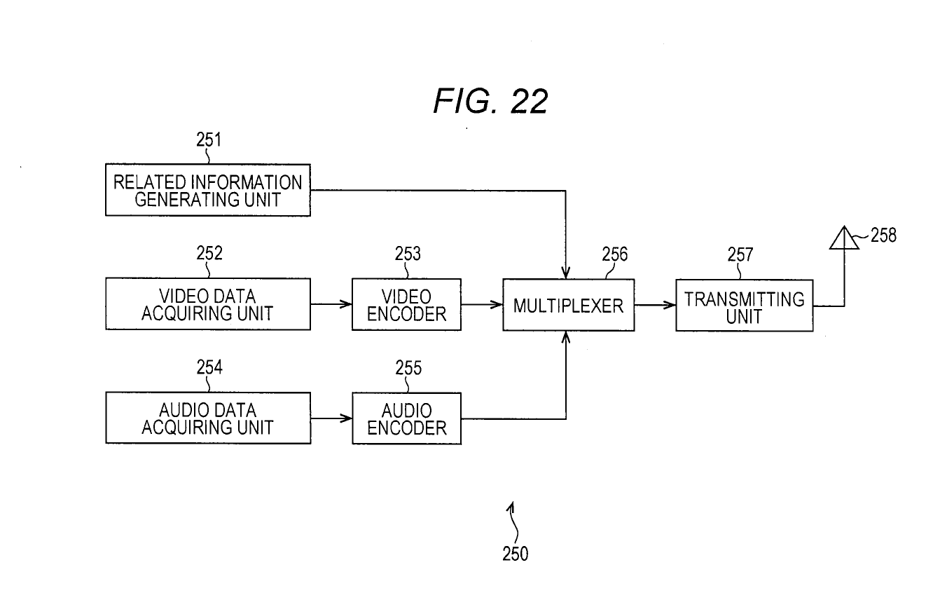

FIG. 22 is a block diagram showing an example structure according to an embodiment of a multi-segment broadcast transmitting device to which the present technique is applied. The multi-segment broadcast transmitting device 250 shown in the drawing is installed in the community broadcast station 32 shown in FIG. 5 or in the 1-Seg retransmitter station 42 shown in FIG. 6, for example, and is used as a multi-segment transmitting device or a 1-Seg transmitting device shown in FIGS. 8 through 10.

In the example shown in the drawing, the multi-segment broadcast transmitting device 250 includes a related information generating unit 251, a video data acquiring unit 252, a video encoder 253, an audio data acquiring unit 254, an audio encoder 255, a multiplexer 256, a transmitting unit 257, and an antenna 258.

The related information generating unit 251 generates related information, such as PSI (Program Specific Information) containing NITs and SDTs of community broadcasting and the like, PSI containing NITs and SDTs of 1-Seg retransmission and the like, or information for performing display using a browser (hereinafter referred to as the display control information), and supplies the related information to the multiplexer 256.

The related information generating unit 251 generates NITs as described above with reference to FIGS. 14 and 16. At this point, the related information generating unit 251 writes connected transmission descriptors contained in predetermined NITs as described above with reference to FIGS. 17, 18, 20, and 21.

The video data acquiring unit 252 acquires video data from an HDD (Hard Disk Drive) (not shown), an external server, or the like, and supplies the video data to the video encoder 253.

The video encoder 253 encodes the video data supplied from the video data acquiring unit 252 by an encoding method such as MPEG2 (Moving Picture Experts Group phase 2), and supplies the encoded video data to the multiplexer 256.

The audio data acquiring unit 254 acquires audio data of from an HDD (not shown), an external server, or the like, and supplies the audio data to the audio encoder 255.

The audio encoder 255 encodes the audio data supplied from the audio data acquiring unit 254 by an encoding method such as MPEG2, and supplies the encoded audio data to the multiplexer 256.

When 1-Seg retransmission is performed, a broadcast wave receiving unit (not shown), instead of the video data acquiring unit 252 and the audio data acquiring unit 254, acquires broadcast signals of a digital terrestrial broadcast that is broadcast in a predetermined physical channel. The data corresponding to the broadcast signals is supplied directly to the multiplexer 256.

The multiplexer 256 generates a TS by multiplexing the related information from the related information generating unit 251, the video data from the video encoder 253, and the audio data from the audio encoder 255, and supplies the TS to the transmitting unit 257. At this point, the multiplexing is performed so that each predetermined NIT generated in the manner described above with reference to FIGS. 14 and 16 is contained in the TS of an appropriate segment.

The transmitting unit 57 transmits the TS supplied from the multiplexer 56 via the antenna 258 at the frequency corresponding to the segment of the current TS.

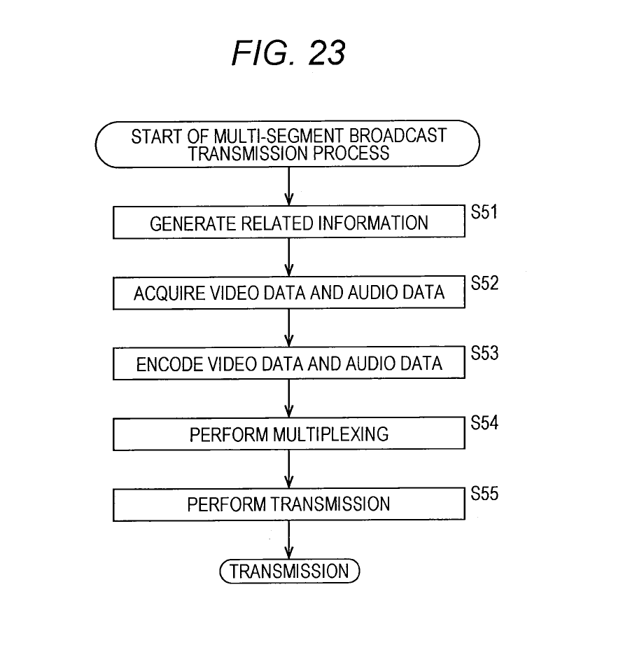

Referring now to the flowchart shown in FIG. 23, an example of a multi-segment broadcast transmission process to be performed by the multi-segment broadcast transmitting device 250 shown in FIG. 9 is described.

In step S51, the related information generating unit 251 generates related information, such as PSI containing NITs and SDTs of community broadcasting and the like, PSI containing NITs and SDTs of 1-Seg retransmission and the like, or display control information, and supplies the related information to the multiplexer 256.

At this point, the related information generating unit 251 generates NITs as described above with reference to FIGS. 14 and 16, so that connected transmission descriptors contained in predetermined NITs are written as described above with reference to FIGS. 17, 18, 20, and 21, for example.

In step S52, the video data acquiring unit 252 acquires video data, and the audio data acquiring unit 254 acquires audio data.

In step S53, the video encoder 253 and the audio encoder 255 encode the video data and the audio data acquired in step S52 by an encoding method such as MPEG2.

When 1-Seg retransmission is performed, a broadcast wave receiving unit (not shown), instead of the video data acquiring unit 252 and the audio data acquiring unit 254, acquires broadcast signals of a digital terrestrial broadcast that is broadcast in a predetermined physical channel. The data corresponding to the broadcast signals is supplied directly to the multiplexer 256.

In step S54, the multiplexer 256 multiplexes the related information generated in step S51 and the data encoded by the processing in step S53, to generate a TS.

At this point, the multiplexing is performed so that each predetermined NIT generated in the manner described above with reference to FIGS. 14 and 16 is contained in the TS of an appropriate segment.

In step S55, the transmitting unit 57 transmits the TS obtained as a result of the processing in step S54 via the antenna 258 at the frequency corresponding to the segment of the current TS.

In this manner, a multi-segment broadcast transmission process is performed.

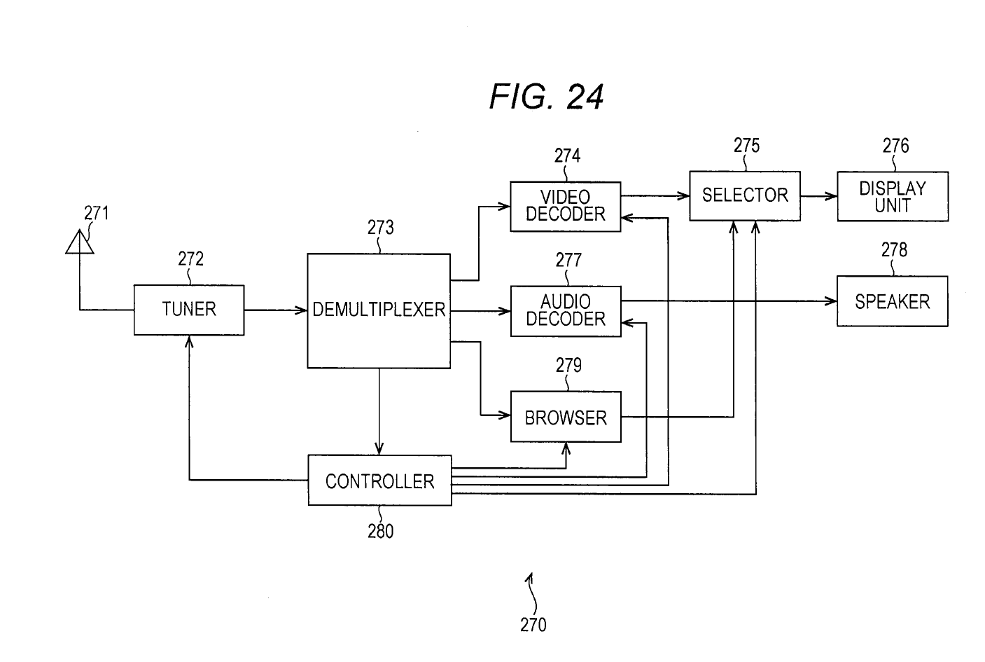

FIG. 24 is a block diagram showing an example structure of a receiving terminal to which the present technique is applied. The receiving terminal 270 shown in the drawing is used as a receiving terminal shown in FIGS. 8 through 10, for example.

In FIG. 24, the receiving terminal 270 includes an antenna 271, a tuner 272, a demultiplexer 273, a video decoder 274, a selector 275, a display unit 276, an audio decoder 277, a speaker 278, a browser 279, and a controller 280.

The tuner 272 performs tuning based on tuning information supplied from the controller 280, and receives a TS that is broadcast in a predetermined logical channel via the antenna 271. The tuner 272 supplies the received TS to the demultiplexer 273.

The demultiplexer 273 separates the TS supplied from the tuner 272 into video data, audio data, display control information, and the respective pieces of information and the like in PSI (Program Specific Information). The demultiplexer 273 supplies the video data to the video decoder 274, and supplies the audio data to the audio decoder 277. Also, the demultiplexer 273 supplies the display control information to the browser 279, and supplies the respective pieces of information and the like in PSI to the controller 280.

Under the control of the controller 280, the video decoder 274 decodes the video data supplied from the demultiplexer 273 by a method compatible with the encoding method used for the video data, and supplies the decoded video data to the selector 275.

Under the control of the controller 280, the selector 275 selects either the video data supplied from video decoder 274 or video data supplied from the browser 279, and supplies the selected video data to the display unit 276. The display unit 276 displays an image based on the video data supplied from the selector 275.

Under the control of the controller 280, the audio decoder 277 decodes the audio data supplied from the demultiplexer 273 by a method compatible with the encoding method used for the audio data, and supplies the decoded audio data to the speaker 278. The speaker 278 outputs sound corresponding to the audio data supplied from the audio decoder 277.

The browser 279 interprets the display control information supplied from the demultiplexer 273, generates video data, and supplies the video data to the selector 275, for example.

The controller 280 sequentially supplies the tuning information about the center segments of the respective physical channels of digital terrestrial broadcasting to the tuner 272. The controller 280 also extracts NITs from the TSs of the center segments of the respective physical channels as described above with reference to FIGS. 14 and 16, and determines whether there is a connected transmission descriptor, to determine whether the current physical channel is a physical channel of multi-segment broadcasting.

If the current physical channel is determined to be a physical channel of multi-segment broadcasting, the controller 280 acquires tuning information by a scanning method described above with reference to FIGS. 13 through 21. Specifically, tuning information is acquired by the center segment scanning method, the 2-segment scanning method, or the all-segment scanning method, and a tuning table is created. The controller 280 then stores the created tuning table into an internal memory (not shown) or the like.

In accordance with an instruction from a user, the controller 280 also supplies the service names registered in the tuning table to the browser 279, for example, and causes the display unit 276 to display the service names. The user sees the services names displayed on the display unit 276, and then selects the service name of a broadcast service to be viewed. Based on the selection, the controller 280 reads the tuning information associated with the name of the service to be viewed from the tuning table, and supplies the tuning information to the tuner 272.

The controller 280 further controls the video decoder 274, the selector 275, the audio decoder 277, and the browser 279 based on the respective pieces of information in the PSI supplied from the demultiplexer 273, for example. Specifically, the controller 280 controls the video decoder 274 and the audio decoder 277 to establish synchronization between the video data output from the video decoder 274 and the audio data output from the audio decoder 277, for example.

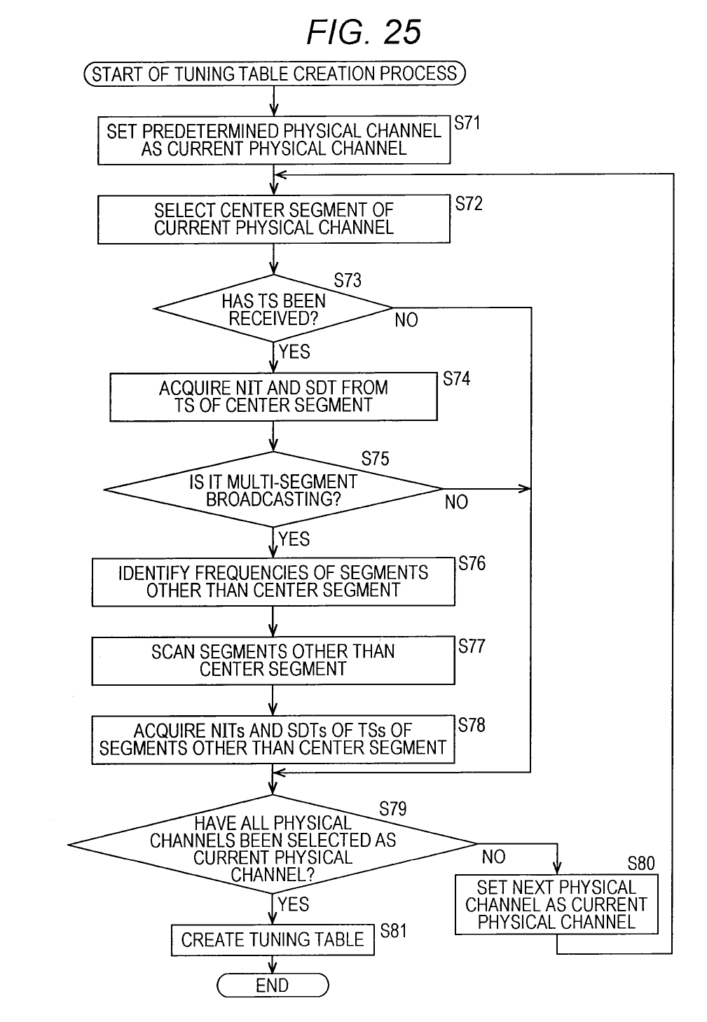

Referring now to the flowchart shown in FIG. 25, an example of a tuning table creation process to be performed by the receiving terminal 270 shown in FIG. 24 is described. This process is performed when a user issues an instruction to create a tuning table, for example.

In step S71, the controller 280 sets a predetermined physical channel (the physical channel with the lowest frequency, for example) as the current physical channel to be used in processing. The controller 280 then supplies the frequency of the center segment of the current physical channel as the tuning information to the tuner 272.

In step S72, the tuner 272 selects the center segment of the current physical channel based on the tuning information supplied from the controller 280.

In step S73, the tuner 272 determines whether the TS of the center segment of the current physical channel has been received. If it is determined that the TS has been received, the process moves on to step S74.

In step S74, the demultiplexer 273 acquires an NIT and an SDT from the TS of the center segment of the current physical channel received by the tuner 272. The demultiplexer 273 then supplies the NIT and the SDT to the controller 280.

In step S75, the controller 280 determines whether the physical channel (the current physical channel) is a physical channel of multi-segment broadcasting based on the received NIT contained in the TS of the center segment. At this point, a check is made to determine whether there is a connected transmission descriptor as described above, to determine whether the current physical channel is a physical channel of multi-segment broadcasting.

If the current physical channel is determined to be a physical channel of multi-segment broadcasting in step S75, the process moves on to step S76.

In step S76, the controller 280 identifies the frequencies of the segments other than the center segment of the current physical channel.

If the center segment scanning method is implemented, for example, the controller 280 identifies the frequencies of the segments other than the center segment based on the descriptions in the TS description areas 122-1 through 122-12 in the “NIT other” shown in FIG. 14.

If the 2-segment scanning method is implemented, for example, the controller 280 identifies the secondary segment based on the content of the description (FIGS. 17 and 18) in the description area 202 in the connected transmission descriptor in the “NIT actual” shown in FIG. 16, and then performs scanning. The controller 280 further identifies the frequencies of the segments other than the center segment based on the descriptions (FIG. 16) in the TS description areas 132-1 through 132-13 in the NIT 131 of the secondary segment.

If the all-segment scanning method is implemented, for example, the controller 280 acquires a bitmap (FIG. 21) based on the content of the description (FIG. 20) in the description area 202 in the connected transmission descriptor, identifies the segment locations of the respective segments, and then identifies the frequencies of the segments other than the center segment.

In step S77, the tuner 272 scans the segments other than the center segment of the current physical channel based on the tuning information supplied from the controller 280.

In step S78, the demultiplexer 273 acquires NITs and SDTs from the TSs of the segments other than the center segment of the current physical channel received by the tuner 272.

If it is determined in step S73 that the TS of the center segment of the current physical channel has not been received, or if the current physical channel is determined not to be a physical channel of multi-segment broadcasting in step S75, the process moves on to step S79.

In step S79, the controller 280 determines whether all the physical channels have been selected as a current physical channel. If it is determined in step S79 that not all the physical channels have been selected as a current physical channel, the controller 280 in step S80 sets the next physical channel (the physical channel with the second highest frequency, for example) as the current physical channel, and the process returns to step S72. The procedures of steps S72 through S80 are repeated until all the physical channels have been selected as a current physical channel.

If it is determined in step S79 that all the physical channels have been selected as a current physical channel, on the other hand, the process moves on to step S81.

In step S81, the controller 280 creates a tuning table based on the NITs and the SDTs acquired by the processing in steps S74 and S78. The controller 280 stores the created tuning table into an internal memory, and ends the process.

In this manner, a tuning table creation process is performed.

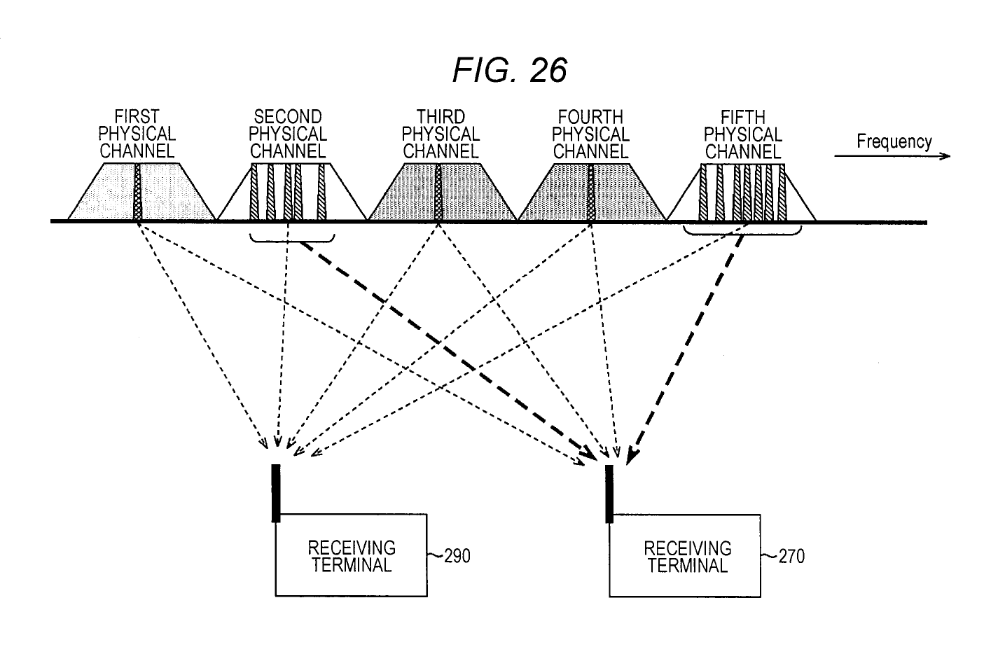

FIG. 26 is a diagram for explaining reception of digital terrestrial broadcasts by the receiving terminal 270 to which the present technique is applied and a conventional receiving terminal 290.

Like the receiving terminal 270, the conventional receiving terminal 290 normally scans the center segments of respective physical channels in ascending frequency order, and creates a tuning table. However, the receiving terminal 290 is not compatible with multi-segment broadcasting, and therefore, does not scan the segments other than the center segment of the physical channel in which multi-segment broadcasting is conducted. Specifically, even if a connected transmission descriptor is detected in the NIT contained in the TS of the center segment of the physical channel in which multi-segment broadcasting is conducted, the conventional receiving terminal 290 does not recognize the physical channel as the physical channel of multi-segment broadcasting.

As a result, as in the other physical channels, the conventional receiving terminal 290 cannot select any segment other than the center segment in the physical channel in which multi-segment broadcasting is conducted. Meanwhile, the conventional receiving terminal 290 does not have a problem such as a malfunction even when multi-segment broadcasting is conducted.

Accordingly, in a case where the receiving terminal 290 receives digital terrestrial broadcast waves, a tuning table is created based on the NIT and the SID contained in the TS of the center segment in each physical channel of the digital terrestrial broadcast waves. That is, a tuning table is created by the process described above with reference to FIG. 1.

In a case where the receiving terminal 270 to which the present technique is applied receives digital terrestrial broadcast waves, on the other hand, a tuning table is created by the process described above with reference to FIG. 25.

Accordingly, the conventional receiving terminal 290 can select only the logical channel of the center segment of each physical channel among first through fifth physical channels, as shown in FIG. 26.

On the other hand, the receiving terminal 270 to which the present technique is applied can select the logical channels of the respective center segments of the first physical channel, the third physical channel, and the fourth physical channel. Further, the receiving terminal 270 can select the logical channels of five segments including the center segment in the second physical channel, and can select the logical channels of seven segments including the center segment in the fifth physical channel.

As described above, according to the present technique, a broadcasting system that does not affect reception of existing digital terrestrial broadcasts, complies with digital terrestrial broadcasting system standards, and maintains interoperability can be constructed. In doing so, there is no need to make drastic changes to the existing structures of receiving terminals and transmission mechanisms, and such a broadcasting system can be realized at low costs.

In view of this, according to the present technique, universal tuning that enables selection of multi-segment broadcasts only through broadcast wave reception can be realized while existing infrastructures are utilized.

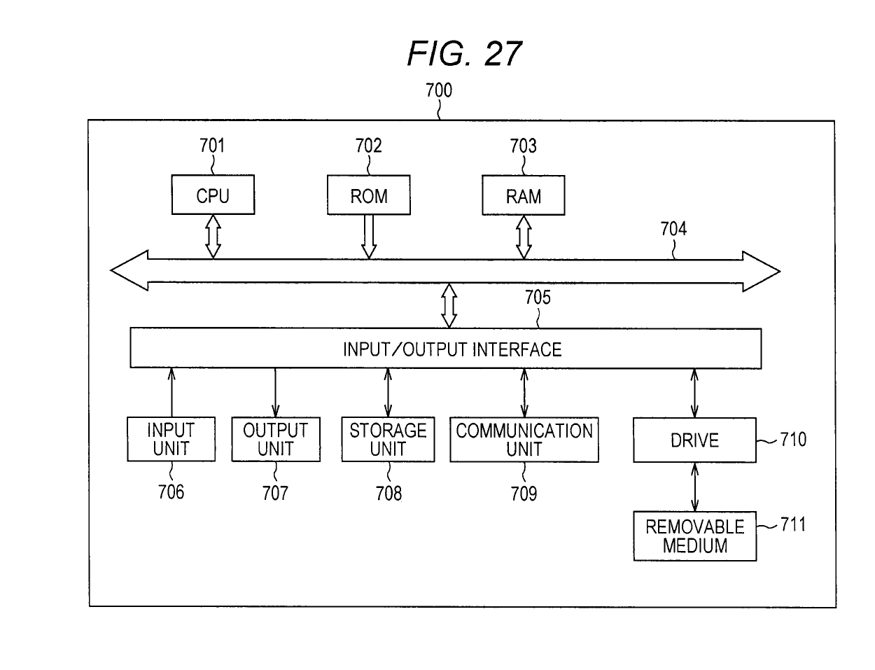

It should be noted that the above described series of processes may be performed by hardware or may be performed by software. In a case where the above described series of processes are performed by software, the program that forms the software may be installed in a computer incorporated into special-purpose hardware, or may be installed from a network or a recording medium into a personal computer that can execute various kinds of functions by installing various kinds of programs, like a general-purpose personal computer 700 shown in FIG. 27, for example.

In FIG. 27, a CPU (Central Processing Unit) 701 performs various kinds of processes in accordance with a program stored in a ROM (Read Only Memory) 702, or a program loaded from a storage unit 708 into a RAM (Random Access Memory) 703. Necessary data for the CPU 701 to perform various kinds of processes and the like are also stored in the RAM 703 as appropriate.

The CPU 701, the ROM 702, and the RAM 703 are connected to one another via a bus 704. An input/output interface 705 is also connected to the bus 704.

The input/output interface 705 has the following components connected thereto: an input unit 706 formed with a keyboard, a mouse, or the like; an output unit 707 formed with a display such as an LCD (Liquid Crystal Display), a speaker, and the like; the storage unit 708 formed with a hard disk or the like; and a communication unit 709 formed with a modem or a network interface card such as a LAN card. The communication unit 709 performs communications via networks including the Internet.

A drive 710 is also connected to the input/output interface 705 where necessary, and a removable medium 711 such as a magnetic disk, an optical disk, a magnetooptical disk, or a semiconductor memory is mounted on the drive as appropriate. A computer program read from such a removable medium is installed in the storage unit 708 where necessary.

In a case where the above described series of processes are performed by software, the program forming the software is installed from a network such as the Internet or a recording medium formed with the removable medium 711 or the like.

This recording medium may not necessarily be formed with the removable medium 711 shown in FIG. 27, which is distributed for delivering programs to users separately from the device and is formed with a magnetic disk (including a floppy disk (a registered trade name) having the program recorded thereon, an optical disk (including a CD-ROM (Compact Dick-Read Only Memory) or a DVD (Digital Versatile Disk)), a magnetooptical disk (including an MD (Mini-Disk) (a registered trade name)), a semiconductor memory, or the like. Instead, the recording medium may be formed with a hard disk or the like that is included in the ROM 702 having the program recorded thereon or in the storage unit 708 that is already incorporated into the device at the time of delivery to users.

The series of processes described in this specification includes processes to be performed in parallel or independently of one another if not necessarily in chronological order, as well as processes to be performed in chronological order in accordance with specified order.

It should be noted that embodiments of the present technique are not limited to the above described embodiments, and various modifications may be made to them without departing from the scope of the present technique.

The present technique can also be in the following forms.

(1) A broadcast wave receiving device including:

a center segment selecting unit that selects a center segment in a predetermined segment location in a predetermined physical channel from among segments obtained by dividing each of physical channels by frequency bands, the physical channels being acquired by dividing broadcast waves by frequency bands;

a descriptor determining unit that determines whether a connected transmission descriptor is acquired, the connected transmission descriptor being information contained in a transport stream that is broadcast in the selected center segment, information about OFDM synchronization among the segments in the predetermined physical channel being written in the connected transmission descriptor;

an other segment selecting unit that sequentially selects the segments other than the center segment in the physical channel when the connected transmission descriptor is acquired; and

a tuning table creating unit that acquires tuning information contained in the transport stream of each of the selected segments, and creates a tuning table.

(2) The broadcast wave receiving device of (1), wherein

the broadcast waves are broadcast waves of digital terrestrial broadcasting, and

the descriptor determining unit

acquires an NIT (Network Information Table) contained in the transport stream that is broadcast in the center segment, and

determines whether the connected transmission descriptor is acquired by determining whether the connected transmission descriptor is contained in the NIT.

(3) The broadcast wave receiving device of (1), wherein

the broadcast waves are broadcast waves of digital terrestrial broadcasting,

the descriptor determining unit

acquires an “NIT actual” contained in the transport stream that is broadcast in the center segment, and

determines whether the connected transmission descriptor is acquired by determining whether the connected transmission descriptor is contained in the “NIT actual”, and

the other segment selecting unit

acquires an “NIT other” contained in the transport stream that is broadcast in the center segment, and

selects the segments other than the center segment by identifying the segment locations of the segments other than the center segment based on information written in the “NIT other”.

(4) The broadcast wave receiving device of (1) or (2), wherein the other segment selecting unit

selects a secondary segment by identifying a segment location of the secondary segment in the predetermined physical channel based on the description in the connected transmission descriptor, and

selects the segments other than the center segment by identifying the segment locations of the segments other than the center segment based on the information contained in the transport stream that is broadcast in the secondary segment.

(5) The broadcast wave receiving device of (1) or (2), wherein the other segment selecting unit selects the segments other than the center segment by identifying the segment locations of the segments other than the center segment based on a bitmap written in the connected transmission descriptor.

(6) A broadcast wave receiving method including the steps of:

selecting a center segment in a predetermined segment location in a predetermined physical channel from among segments obtained by dividing each of physical channels by frequency bands, the physical channels being acquired by dividing broadcast waves by frequency bands, a center segment selecting unit selecting the center segment;

determining whether a connected transmission descriptor is acquired, the connected transmission descriptor being information contained in a transport stream that is broadcast in the selected center segment, information about OFDM synchronization among the segments in the predetermined physical channel being written in the connected transmission descriptor, a descriptor determining unit determining whether the connected transmission descriptor is acquired;

sequentially selecting the segments other than the center segment in the physical channel when the connected transmission descriptor is acquired, an other segment selecting unit sequentially selecting the segments other than the center segment; and

acquiring tuning information contained in the transport stream of each of the selected segments, and creating a tuning table, a tuning table creating unit acquiring the tuning information and creating the tuning table.

(7) A program for causing a computer to function as a broadcast wave receiving device that includes:

a center segment selecting unit that selects a center segment in a predetermined segment location in a predetermined physical channel from among segments obtained by dividing each of physical channels by frequency bands, the physical channels being acquired by dividing broadcast waves by frequency bands;

a descriptor determining unit that determines whether a connected transmission descriptor is acquired, the connected transmission descriptor being information contained in a transport stream that is broadcast in the selected center segment, information about OFDM synchronization among the segments in the predetermined physical channel being written in the connected transmission descriptor;

an other segment selecting unit that sequentially selects the segments other than the center segment in the physical channel when the connected transmission descriptor is acquired; and

a tuning table creating unit that acquires tuning information contained in the transport stream of each of the selected segments, and creates a tuning table.

(8) A recording medium on which the program of (7) is recorded.

(9) A broadcast wave transmitting device including:

a related information generating unit that generates related information about selection of a logical channel corresponding to segments obtained by dividing each of physical channels by frequency bands, the physical channels being obtained by dividing broadcast waves by frequency bands;

a multiplexing unit that multiplexes the related information and audio data or video data, to incorporate the generated related information into a transport stream to be broadcast in a center segment in a predetermined segment location in a predetermined physical channel; and

a transmitting unit that transmits the transport stream obtained through the multiplexing as a broadcast wave of the center segment,

the related information containing information indicating that multi-segment broadcasting is conducted in the predetermined physical channel to transmit different broadcasts in the respective segments, and information for identifying segment locations of the segments in the predetermined physical channel.

(10) The broadcast wave transmitting device of (9), wherein

the broadcast waves are broadcast waves of digital terrestrial broadcasting, and

the related information generating unit generates a connected transmission descriptor as the information indicating that multi-segment broadcasting is conducted, the connected transmission descriptor being written in part of an NIT (Network Information Table) contained in the transport stream to be broadcast in the center segment, information about OFDM synchronization among the segments in the predetermined physical channel being written in the connected transmission descriptor.

(11) The broadcast wave transmitting device of (9), wherein

the broadcast waves are broadcast waves of digital terrestrial broadcasting, and

the related information generating unit

generates a connected transmission descriptor as the information indicating that multi-segment broadcasting is conducted, the connected transmission descriptor being written in part of an “NIT actual” contained in the transport stream to be broadcast in the center segment, information about OFDM synchronization among the segments in the predetermined physical channel being written in the connected transmission descriptor, and

generates the information for identifying the segment locations of the segments other than the center segment in the predetermined physical channel, the information being written in an “NIT other” contained in the transport stream to be broadcast in the center segment.

(12) The broadcast wave transmitting device of (9) or (10), wherein

the broadcast waves are broadcast waves of digital terrestrial broadcasting, and

the related information generating unit

generates a connected transmission descriptor as the information indicating that multi-segment broadcasting is conducted, the connected transmission descriptor being written in part of an NIT contained in the transport stream to be broadcast in the center segment, information about OFDM synchronization among the segments in the predetermined physical channel being written in the connected transmission descriptor, and

writes, in the connected transmission descriptor, information for identifying a segment location of a secondary segment in the predetermined physical channel,

the information for identifying the segment locations of the segments other than the center segment in the predetermined physical channel being contained in a transport stream to be broadcast in the secondary segment.

(13) The broadcast wave transmitting device of (9) or (10), wherein

the broadcast waves are broadcast waves of digital terrestrial broadcasting, and

the related information generating unit

generates a connected transmission descriptor as the information indicating that multi-segment broadcasting is conducted, the connected transmission descriptor being written in part of an NIT contained in the transport stream to be broadcast in the center segment, information about OFDM synchronization among the segments in the predetermined physical channel being written in the connected transmission descriptor, and

generates a bitmap written in the connected transmission descriptor as the information for identifying the segment locations of the segments other than the center segment in the predetermined physical channel.

(14) A broadcast wave transmitting method including the steps of:

generating related information about selection of a logical channel corresponding to segments obtained by dividing each of physical channels by frequency bands, the physical channels being obtained by dividing broadcast waves by frequency bands, a related information generating unit generating the related information;

multiplexing the related information and audio data or video data, to incorporate the generated related information into a transport stream to be broadcast in a center segment in a predetermined segment location in a predetermined physical channel, a multiplexing unit performing the multiplexing; and

transmitting the transport stream obtained through the multiplexing as a broadcast wave of the center segment, a transmitting unit transmitting the transport stream,

the related information containing information indicating that multi-segment broadcasting is conducted in the predetermined physical channel to transmit different broadcasts in the respective segments, and information for identifying segment locations of the segments in the predetermined physical channel.

(15) A program for causing a computer to function as a broadcast wave transmitting device that includes:

a related information generating unit that generates related information about selection of a logical channel corresponding to segments obtained by dividing each of physical channels by frequency bands, the physical channels being obtained by dividing broadcast waves by frequency bands;

a multiplexing unit that multiplexes the related information and audio data or video data, to incorporate the generated related information into a transport stream to be broadcast in a center segment in a predetermined segment location in a predetermined physical channel; and

a transmitting unit that transmits the transport stream obtained through the multiplexing as a broadcast wave of the center segment,

the related information containing information indicating that multi-segment broadcasting is conducted in the predetermined physical channel to transmit different broadcasts in the respective segments, and information for identifying segment locations of the segments in the predetermined physical channel.

(16) A recording medium on which the program of (15) is recorded.

### REFERENCE SIGNS LIST

250 Multi-segment broadcast transmitting device, 251 Related information generating unit, 252 Video data acquiring unit, 253 Video encoder, 254 Audio data acquiring unit, 255 Audio encoder, 256 Multiplexer, 257 Transmitting unit, 270 Receiving terminal, 271 Antenna, 272 Tuner, 273 Demultiplexer, 274 Video decoder, 275 Selector, 276 Display unit, 277 Audio decoder, 279 Browser, 280 Controller

1. A broadcast wave receiving device comprising:
a center segment selecting unit configured to select a center segment in a predetermined segment location in a predetermined physical channel from among a plurality of segments obtained by dividing each of a plurality of physical channels by frequency bands, the physical channels being acquired by dividing broadcast waves by frequency bands;
a descriptor determining unit configured to determine whether a connected transmission descriptor is acquired, the connected transmission descriptor being information contained in a transport stream that is broadcast in the selected center segment, information about OFDM synchronization among the segments in the predetermined physical channel being written in the connected transmission descriptor;
an other segment selecting unit configured to sequentially select the segments other than the center segment in the physical channel when the connected transmission descriptor is acquired; and
a tuning table creating unit configured to acquire tuning information contained in a transport stream of each of the selected segments, and creates a tuning table.

2. The broadcast wave receiving device according to claim 1, wherein
the broadcast waves are broadcast waves of digital terrestrial broadcasting, and
the descriptor determining unit
acquires an NIT (Network Information Table) contained in the transport stream that is broadcast in the center segment, and
determines whether the connected transmission descriptor is acquired by determining whether the connected transmission descriptor is contained in the NIT.

3. The broadcast wave receiving device according to claim 1, wherein
the broadcast waves are broadcast waves of digital terrestrial broadcasting,
the descriptor determining unit
acquires an “NIT actual” contained in the transport stream that is broadcast in the center segment, and
determines whether the connected transmission descriptor is acquired by determining whether the connected transmission descriptor is contained in the “NIT actual”, and
the other segment selecting unit
acquires an “NIT other” contained in the transport stream that is broadcast in the center segment, and
selects the segments other than the center segment by identifying the segment locations of the segments other than the center segment based on information written in the “NIT other”.

4. The broadcast wave receiving device according to claim 1, wherein the other segment selecting unit
selects a secondary segment by identifying a segment location of the secondary segment in the predetermined physical channel based on a description in the connected transmission descriptor, and
selects the segments other than the center segment by identifying the segment locations of the segments other than the center segment based on the information contained in a transport stream that is broadcast in the secondary segment.

5. The broadcast wave receiving device according to claim 1, wherein the other segment selecting unit selects the segments other than the center segment by identifying the segment locations of the segments other than the center segment based on a bitmap written in the connected transmission descriptor.

6. A broadcast wave receiving method comprising the steps of:
selecting a center segment in a predetermined segment location in a predetermined physical channel from among a plurality of segments obtained by dividing each of a plurality of physical channels by frequency bands, the physical channels being acquired by dividing broadcast waves by frequency bands, a center segment selecting unit selecting the center segment;
determining whether a connected transmission descriptor is acquired, the connected transmission descriptor being information contained in a transport stream that is broadcast in the selected center segment, information about OFDM synchronization among the segments in the predetermined physical channel being written in the connected transmission descriptor, a descriptor determining unit determining whether the connected transmission descriptor is acquired;
sequentially selecting the segments other than the center segment in the physical channel when the connected transmission descriptor is acquired, an other segment selecting unit sequentially selecting the segments other than the center segment; and
acquiring tuning information contained in a transport stream of each of the selected segments, and creating a tuning table, a tuning table creating unit acquiring the tuning information and creating the tuning table.

7. A program for causing a computer to function as a broadcast wave receiving device that comprises:
a center segment selecting unit configured to select a center segment in a predetermined segment location in a predetermined physical channel from among a plurality of segments obtained by dividing each of a plurality of physical channels by frequency bands, the physical channels being acquired by dividing broadcast waves by frequency bands;
a descriptor determining unit configured to determine whether a connected transmission descriptor is acquired, the connected transmission descriptor being information contained in a transport stream that is broadcast in the selected center segment, information about OFDM synchronization among the segments in the predetermined physical channel being written in the connected transmission descriptor;
an other segment selecting unit configured to sequentially select the segments other than the center segment in the physical channel when the connected transmission descriptor is acquired; and
a tuning table creating unit configured to acquire tuning information contained in a transport stream of each of the selected segments, and creates a tuning table.

8. A recording medium on which the program of claim 7 is recorded.

9. A broadcast wave transmitting device comprising:
a related information generating unit configured to generate related information about selection of a logical channel corresponding to a plurality of segments obtained by dividing each of a plurality of physical channels by frequency bands, the physical channels being obtained by dividing broadcast waves by frequency bands;
a multiplexing unit configured to multiplex the related information and audio data or video data, to incorporate the generated related information into a transport stream to be broadcast in a center segment in a predetermined segment location in a predetermined physical channel; and
a transmitting unit configured to transmit the transport stream obtained through the multiplexing as a broadcast wave of the center segment,
the related information containing information indicating that multi-segment broadcasting is conducted in the predetermined physical channel to transmit different broadcasts in the respective segments, and information for identifying segment locations of the segments in the predetermined physical channel.

10. The broadcast wave transmitting device according to claim 9, wherein
the broadcast waves are broadcast waves of digital terrestrial broadcasting, and
the related information generating unit generates a connected transmission descriptor as the information indicating that multi-segment broadcasting is conducted, the connected transmission descriptor being written in part of an NIT (Network Information Table) contained in the transport stream to be broadcast in the center segment, information about OFDM synchronization among the segments in the predetermined physical channel being written in the connected transmission descriptor.

11. The broadcast wave transmitting device according to claim 9, wherein
the broadcast waves are broadcast waves of digital terrestrial broadcasting, and
the related information generating unit
generates a connected transmission descriptor as the information indicating that multi-segment broadcasting is conducted, the connected transmission descriptor being written in part of an “NIT actual” contained in the transport stream to be broadcast in the center segment, information about OFDM synchronization among the segments in the predetermined physical channel being written in the connected transmission descriptor, and
generates the information for identifying the segment locations of the segments other than the center segment in the predetermined physical channel, the information being written in an “NIT other” contained in the transport stream to be broadcast in the center segment.

12. The broadcast wave transmitting device according to claim 9, wherein
the broadcast waves are broadcast waves of digital terrestrial broadcasting, and
the related information generating unit
generates a connected transmission descriptor as the information indicating that multi-segment broadcasting is conducted, the connected transmission descriptor being written in part of an NIT contained in the transport stream to be broadcast in the center segment, information about OFDM synchronization among the segments in the predetermined physical channel being written in the connected transmission descriptor, and
writes, in the connected transmission descriptor, information for identifying a segment location of a secondary segment in the predetermined physical channel,
the information for identifying the segment locations of the segments other than the center segment in the predetermined physical channel being contained in a transport stream to be broadcast in the secondary segment.

13. The broadcast wave transmitting device according to claim 9, wherein
the broadcast waves are broadcast waves of digital terrestrial broadcasting, and
the related information generating unit
generates a connected transmission descriptor as the information indicating that multi-segment broadcasting is conducted, the connected transmission descriptor being written in part of an NIT contained in the transport stream to be broadcast in the center segment, information about OFDM synchronization among the segments in the predetermined physical channel being written in the connected transmission descriptor, and
generates a bitmap to be written in the connected transmission descriptor as the information for identifying the segment locations of the segments other than the center segment in the predetermined physical channel.

14. A broadcast wave transmitting method comprising the steps of:
generating related information about selection of a logical channel corresponding to a plurality of segments obtained by dividing each of a plurality of physical channels by frequency bands, the physical channels being obtained by dividing broadcast waves by frequency bands, a related information generating unit generating the related information;
multiplexing the related information and audio data or video data, to incorporate the generated related information into a transport stream to be broadcast in a center segment in a predetermined segment location in a predetermined physical channel, a multiplexing unit performing the multiplexing; and
transmitting the transport stream obtained through the multiplexing as a broadcast wave of the center segment, a transmitting unit transmitting the transport stream,
the related information containing information indicating that multi-segment broadcasting is conducted in the predetermined physical channel to transmit different broadcasts in the respective segments, and information for identifying segment locations of the segments in the predetermined physical channel.

15. A program for causing a computer to function as a broadcast wave transmitting device that comprises:
a related information generating unit configured to generate related information about selection of a logical channel corresponding to a plurality of segments obtained by dividing each of a plurality of physical channels by frequency bands, the physical channels being obtained by dividing broadcast waves by frequency bands;
a multiplexing unit configured to multiplex the related information and audio data or video data, to incorporate the generated related information into a transport stream to be broadcast in a center segment in a predetermined segment location in a predetermined physical channel; and
a transmitting unit configured to transmit the transport stream obtained through the multiplexing as a broadcast wave of the center segment,
the related information containing information indicating that multi-segment broadcasting is conducted in the predetermined physical channel to transmit different broadcasts in the respective segments, and information for identifying segment locations of the segments in the predetermined physical channel.

16. A recording medium on which the program of claim 15 is recorded.
